(19) United States
(12) Patent Application Publication
(10) Pub. No.: US 2025/0174072 A1
(43) Pub. Date: May 29, 2025

(54) SYSTEMS AND METHODS FOR PROVIDING TRANSIENT FEATURES ASSOCIATED WITH OUTPUTS IN ELECTRONIC GAMING

(71) Applicant: Aristocrat Technologies, Inc., Las Vegas, NV (US)

(72) Inventors: Rogelio Decasa, JR., Renton, WA (US); Nicholas Farina, Granger, IN (US); Hanna Sanborn, Georgetown, TX (US); Kelly Lockheed, Elkridge, MD (US)

(21) Appl. No.: 18/956,575

(22) Filed: Nov. 22, 2024

Related U.S. Application Data
(60) Provisional application No. 63/604,099, filed on Nov. 29, 2023.
(60) Provisional application No. 63/603,841, filed on Nov. 29, 2023.

(51) Int. Cl. G07F 17/32; G07F 17/34

(52) U.S. Cl. CPC G07F 17/3211; G07F 17/34

(57) ABSTRACT

A gaming system configured to: display an electronic game including reels and transient characters each associated with one of the reels and displayed for a predetermined number of spins; randomly determine a prize and a number of health points for each character; spin and stop the reels and display a set of symbols on each stopped reel; determine, for each stopped reel, whether the set of symbols includes an attack symbol that causes the number of health points of the associated character to reach zero; when the number of health points for any of the characters reaches zero, generate an award that includes the prize for the character having zero health points; remove each character having zero remaining spins, determined after the reels are stopped; and for each removed character, display a new character and determine a prize and a number of health points for the new character.

### CROSS REFERENCE TO RELATED APPLICATIONS

This application claims the benefit of priority to U.S. Provisional Patent Application No. 63/604,099, filed Nov. 29, 2023, and U.S. Provisional Patent Application No. 63/603,841, filed Nov. 29, 2023, the contents and disclosures of which are hereby incorporated by reference herein in their entireties.

### TECHNICAL FIELD

The field of disclosure relates generally to electronic gaming, and more particularly, systems and methods for providing transient features (e.g., above-reel characters) associated with outputs (e.g., awards, upgrades, bonuses) in electronic gaming.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, a gaming system including a processor and a memory storing instructions thereon is provided. The instructions, when executed by the processor, cause the processor to: control a display device to display an electronic game including a set of reels and transient characters, wherein each transient character is associated with one of the reels and is displayed for a predetermined number of spins; randomly determine a prize and a number of health points for each transient character; control the display device to spin and stop the set of reels and display a set of symbols on each stopped reel; determine, for each stopped reel, whether the set of symbols includes an attack symbol that causes the number of health points of the transient character associated with the reel to reach zero; when the number of health points for any of the transient characters reaches zero, generate an award that includes the prize for the transient character having zero health points; control the display device to remove each transient character having zero remaining spins, determined after the reels are stopped; and for each removed transient character, control the display device to display a new transient character and determine a prize and a number of health points for the new transient character. The instructions may direct additional, less, or other functionality including that which is described herein.

In another aspect, a non-transitory computer-readable medium containing instructions stored thereon is provided. The instructions, when executed by a processor, cause the processor to: control a display device to display an electronic game including a set of reels and transient characters, wherein each transient character is associated with one of the reels and is displayed for a predetermined number of spins; randomly determine a prize and a number of health points for each transient character; control the display device to spin and stop the set of reels and display a set of symbols on each stopped reel; determine, for each stopped reel, whether the set of symbols includes an attack symbol that causes the number of health points of the transient character associated with the reel to reach zero; when the number of health points for any of the transient characters reaches zero, generate an award that includes the prize for the transient character having zero health points; control the display device to remove each transient character having zero remaining spins, determined after the reels are stopped; and for each removed transient character, control the display device to display a new transient character and determine a prize and a number of health points for the new transient character. The instructions may direct additional, less, or other functionality including that which is described herein.

In another aspect, a computer-implemented method for providing an electronic game on an electronic gaming device is provided. The method includes: controlling a display device to display the electronic game including a set of reels and transient characters, wherein each transient character is associated with one of the reels and is displayed for a predetermined number of spins; randomly determining a prize and a number of health points for each transient character; controlling the display device to spin and stop the set of reels and display a set of symbols on each stopped reel; determining, for each stopped reel, whether the set of symbols includes an attack symbol that causes the number of health points of the transient character associated with the reel to reach zero; when the number of health points for any of the transient characters reaches zero, generating an award that includes the prize for the transient character having zero health points; controlling the display device to remove each transient character having zero remaining spins, determined after the reels are stopped; and for each removed transient character, controlling the display device to display a new transient character and determining a prize and a number of health points for the new transient character. The method may include additional, less, or other actions including those described herein.

### BRIEF DESCRIPTION OF THE DRAWINGS

FIG. 1 is an exemplary diagram showing several gaming machines networked with various gaming related servers.

FIG. 2A is a block diagram showing various functional elements of an exemplary gaming machine.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is a flow chart of a process for executing a game instance of an electronic game for display on a gaming device.

FIG. 5 is an example user interface or screen capture showing an outcome of an instance of the electronic game according to the process of FIG. 4.

FIGS. 6-10 are example user interfaces or screen captures showing a sequence of attacks on transient characters and associated awards generated on defeated characters as a result of the outcome of FIG. 5.

FIG. 11A is an example user interface or screen capture showing a free spins feature game of the electronic game that may be triggered for one of the defeated characters of FIGS. 6-10.

FIG. 11B is an example user interface or screen capture showing an expanded reel mode of the free spins feature game of FIG. 11A.

FIG. 12A is a table showing an exemplary lookup table of values associated with characters and awards, in accordance with the present disclosure.

FIG. 12B is a table showing an exemplary lookup table of values associated with the weight of prize values, in accordance with the present disclosure.

FIG. 13 is a flow chart of a method for providing an electronic game on an electronic gaming device, in accordance with the present disclosure.

FIG. 14A is a flow chart of a process for executing a game instance of an electronic game for display on a gaming device, in accordance with the present disclosure.

FIG. 14B continues the flowchart shown in FIG. 14A.

FIGS. 15-18 are example user interfaces or screen captures showing a sequence of a game instance according to the process of FIG. 14A and FIG. 14B.

FIGS. 19A and 19B are example user interfaces or screen captures showing a sequence of a transient character of the electronic game that is defeated and replaced during a game instance of FIGS. 15-18.

FIGS. 20A and 20B are example user interfaces or screen captures showing a sequence of a transient character of the electronic game that is removed and replaced after a number of spins for the character reaches zero during another game instance.

FIG. 21 is an example user interface or screen display showing display of an animation effect provided in conjunction with a transient character being removed.

FIGS. 22A-22E are example user interfaces or screen captures showing a pick bonus game of the electronic game that may be triggered when a transient character is removed.

Corresponding reference numerals used through the drawings indicate corresponding elements.

### DETAILED DESCRIPTION

In conventional reel-based games, in a given game outcome, a gaming device may display one or more feature symbols or objects in a viewable portion of a set of reels (e.g., within a play area) along with other base symbols or objects. Feature symbols that appear in the play area may trigger a feature game (e.g., a bonus game or a special mode of game play). The feature game may be triggered based upon a single feature symbol or a threshold count of feature symbols (e.g., six feature symbols) appearing within the play area in a result of a base reel game. The variability and flexibility in providing awards and displaying supplemental visual effects in conventional reel-based games remain limited, however. Furthermore, in conventional gaming, the feature symbols that are included in the result of the base reel game may be associated to some extent with metamorphics or other graphical elements provided on the display, but are typically not utilized for unlocking awards beyond the evaluation of such symbols for credit values or symbol combinations or using such symbols for triggering a feature game. Consequently, the variability and flexibility with which the feature symbols may be used is limited in known games. A technical need exists to address at least the above limitations to facilitate increased variability in the game play while reducing or maintaining the computational resources used and while doing so during game play (e.g., and maintaining RTP).

Example embodiments described herein relate to systems and methods for providing an electronic game that includes transient characters and attack symbols that may land in a play area and operate against the transient characters to unlock associated awards. The characters are “transient” in that they remain on screen for a limited number of spins or plays of the game. The objective of the game is to defeat the characters with attack symbols before they exit and/or are removed from the screen. Notably, the present disclosure provides embodiments of transient characters in an electronic game that may be configured for real money gaming and/or non-real money gaming (e.g., social gaming and/or inputs and/or outputs are provided with non-real-money credits).

To facilitate the electronic game, one or more lookup operations may be performed for determining characteristics of the transient characters at the beginning of the game and for any new transient characters that may replace transient characters that are defeated or exit the screen. Existing gaming devices may not be configured with the resources to perform these computations in an effective and/or efficient manner while also managing payout volatility and RTP. The systems and methods described herein include the provision of backend operations and information stored in memory that enables the game mechanics described herein to be implemented while maintaining or reducing the computational resources required to ensure all objectives of the electronic game are met. Furthermore, as the reel areas are played in conjunction with the transient characters, a user interface providing the electronic game must be configured to display information and visual feedback related to the attack symbols appearing in the reel areas and the status of the transient characters during game play, and to do so within a limited display area. The systems and methods described herein include display of visual indications that visually inform progress of the game and that clearly indicate the status of the transient characters as well as the effect that the attack symbols have on the characters.

The technical problems addressed herein include at least one of: (i) inability of known systems to provide transient characters associated with outputs in electronic gaming; (ii) inability of known systems to efficiently communicate statuses of transient characters in electronic gaming; (iii) inability of known systems to dynamically provide new transient characters on a display while controlling RTP; (iv) inability of known systems to provide variability and flexibility to transient characters while controlling RTP; (v) inability of known systems to display large quantities of complex information in a relatively small display area; (vi) inability of known system to dynamically adjust the size of a reel matrix based on game state while controlling RTP.

The resulting technical effects and/or technical benefits achieved by this disclosure include at least one of: (i) providing transient characters associated with outputs in electronic gaming while controlling RTP; (ii) efficiently communicating statuses of transient characters in electronic gaming; (iii) dynamically providing new transient characters on a display while controlling RTP; (iv) improving the variability and flexibility of transient characters while controlling RTP; (v) displaying large quantities of complex information in a relatively small display area; (vi) communicating complex information with easy-to-understand animations on a display; (viii) efficiently communicating different game rules on a display during game play; (ix) providing versatility as to which devices (e.g., EGMs, mobile devices, etc.) the games described herein may be played on because of the efficient display area designs described herein; (x) reducing computational expenses while improving visual clarity by using multiple lookup tables to control RTP and transient characters to display outcomes; and (xi) dynamically adjusting the size of a reel matrix based on game state while controlling RTP.

Various interface improvements are provided herein to efficiently and effectively communicate information. For instance, during play of an electronic game, as described herein, various animations are provided to communicate which transient characters are currently provided and the outputs associated therewith as well as which symbols cause “attacks” on the transient characters (e.g., and how many attacks are provided on the transient characters).

Example embodiments described herein may be provided in combination or in isolation to summarize and present game mechanics in a manner that improves the efficiency of computer systems (e.g., electronic gaming systems including electronic gaming devices). Each example system provides an improved user interface displaying a limited set of information to players, potentially within a small screen, such that players can more quickly understand the current status of the game. The systems and methods provide improved display device functionality (e.g., on a gaming device) by providing multiple visual indicators that communicate game mechanics described herein to players. The systems and methods provided herein also improve display and device efficiency by eliminating the need for complex information pages describing game mechanics to players. Because of at least the easily-understood animations, symbols, and indicators displayed, the games described herein can be played and understood on a single screen substantially smaller than some of the EGMs described herein (e.g., a mobile device such as a cell phone), thus removing the need for multiple displays with complex information screens including lengthy text.

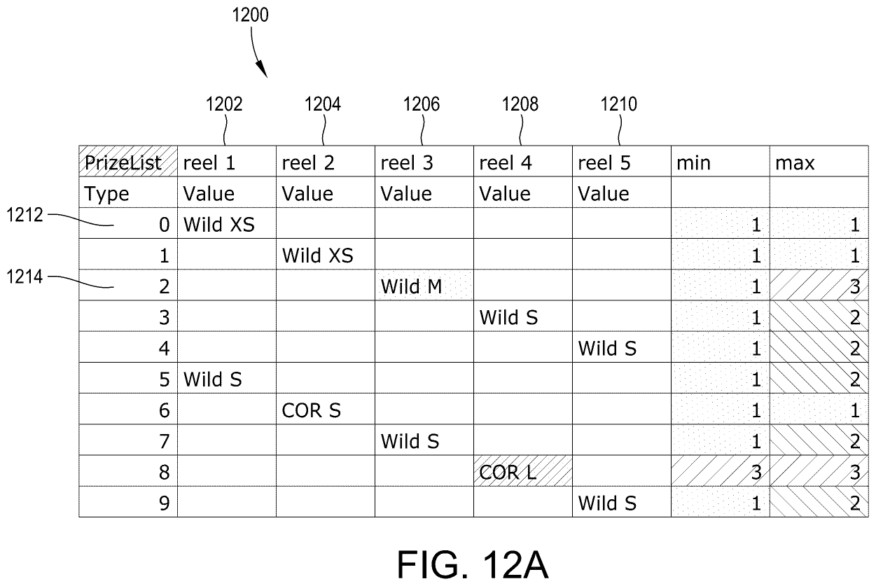

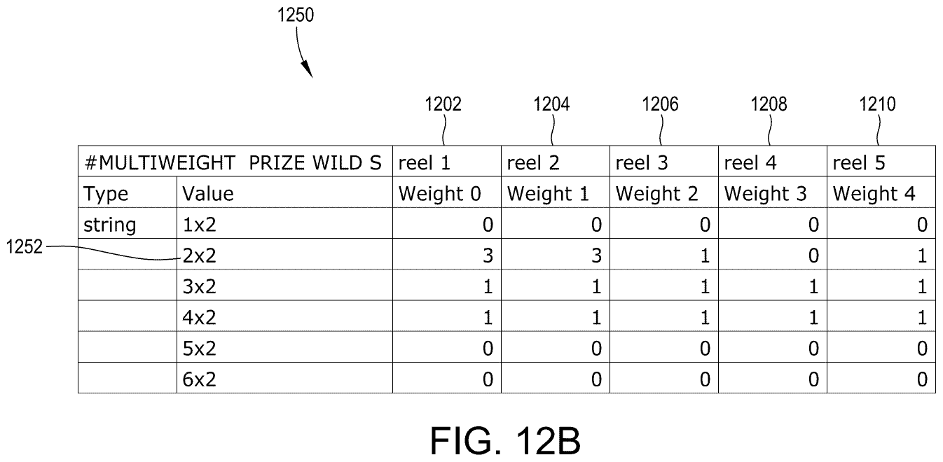

Further, various weighted tables, lookup tables, and/or RNG calls may be utilized in providing the transient characters described herein while controlling RTP. For instance, the process of providing a new transient character may include first selecting a new character type and/or health of the new character (e.g., see FIG. 12A) based on a first lookup table and/or RNG call and then selecting an output associated with the new character (e.g., see FIG. 12B) based on a second lookup table and/or RNG call. The various tables described herein are configured to provide flexibility and variability in the transient characters while also controlling RTP. In other words, the weights of various features, the character types, and/or the health ranges, as examples, for transient characters are configured such that when the electronic game including the transient characters is provided (e.g., and the outputs associated therewith), RTP will remain in a target range.

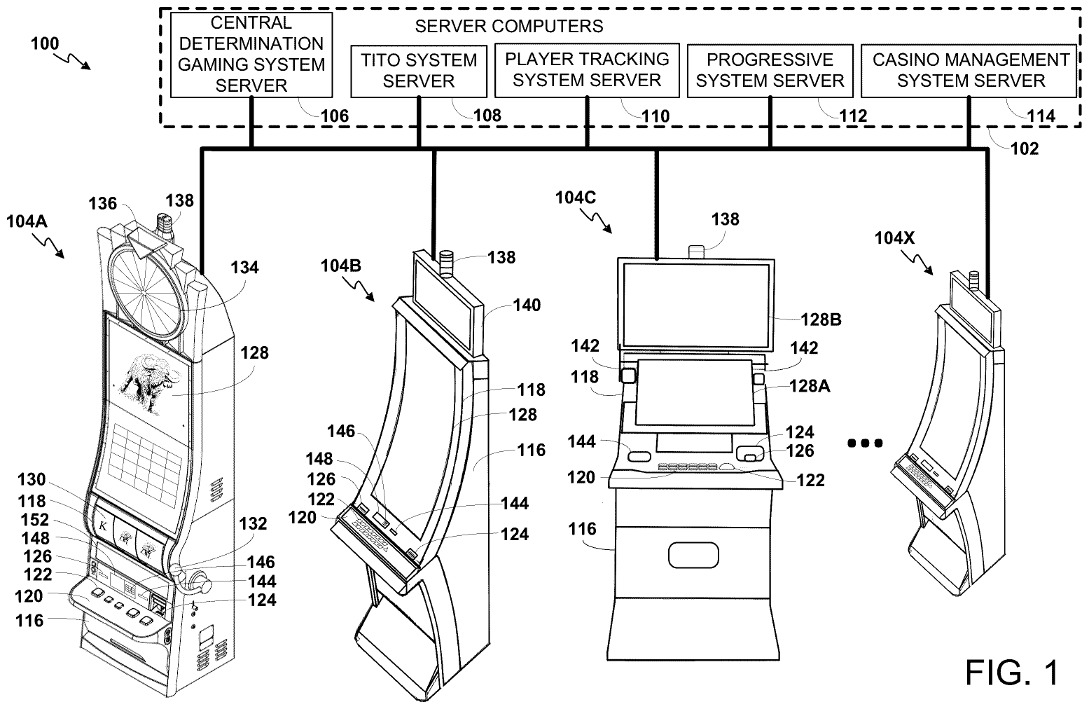

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

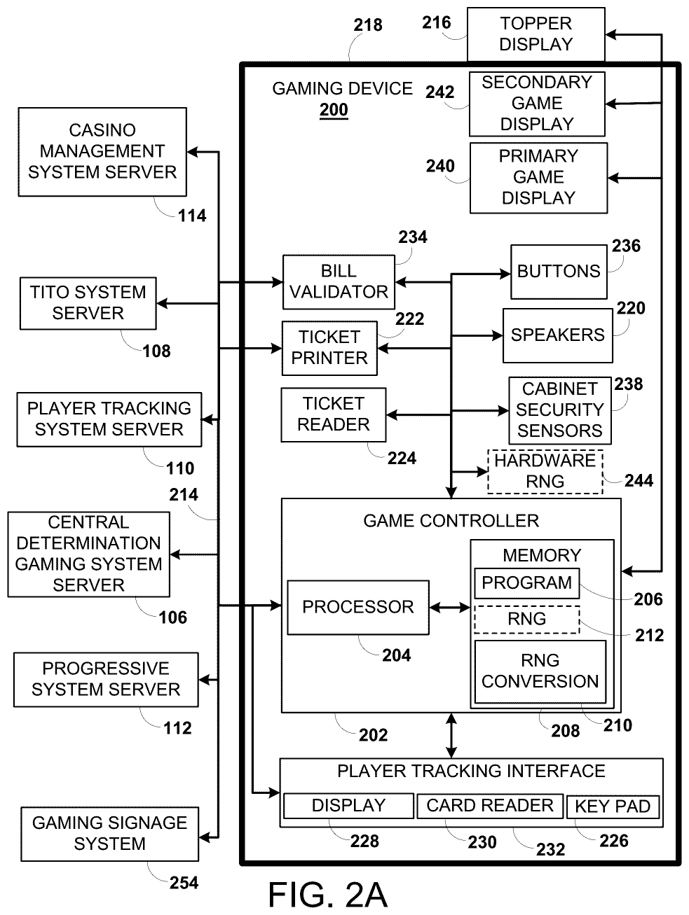

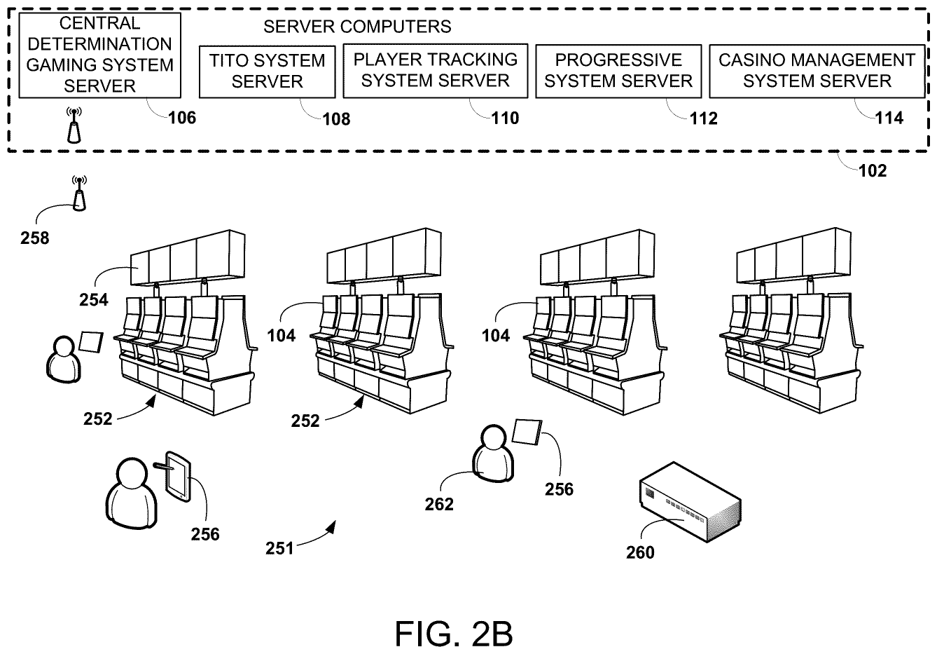

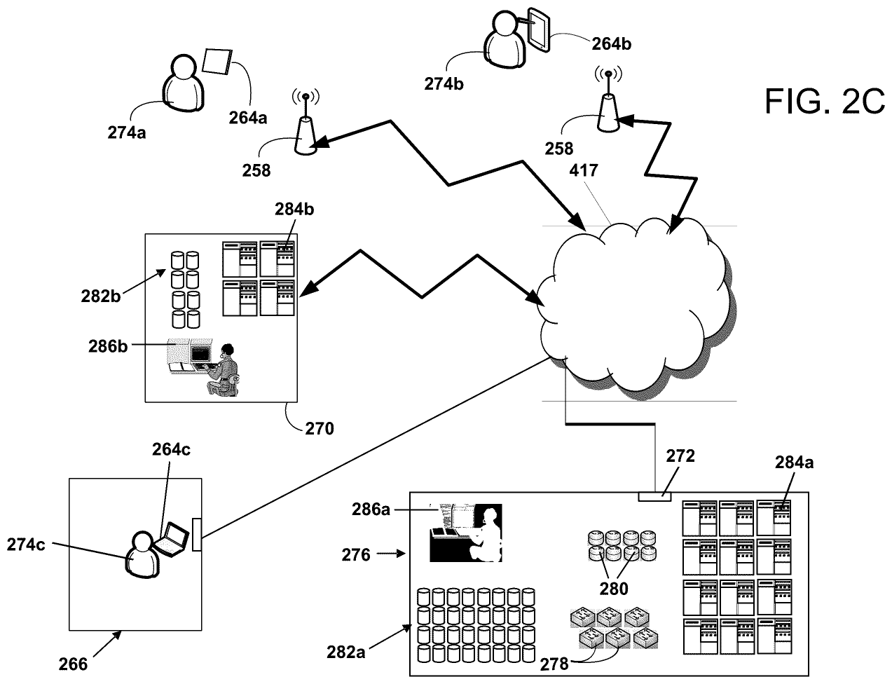

Many or all of the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286b. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

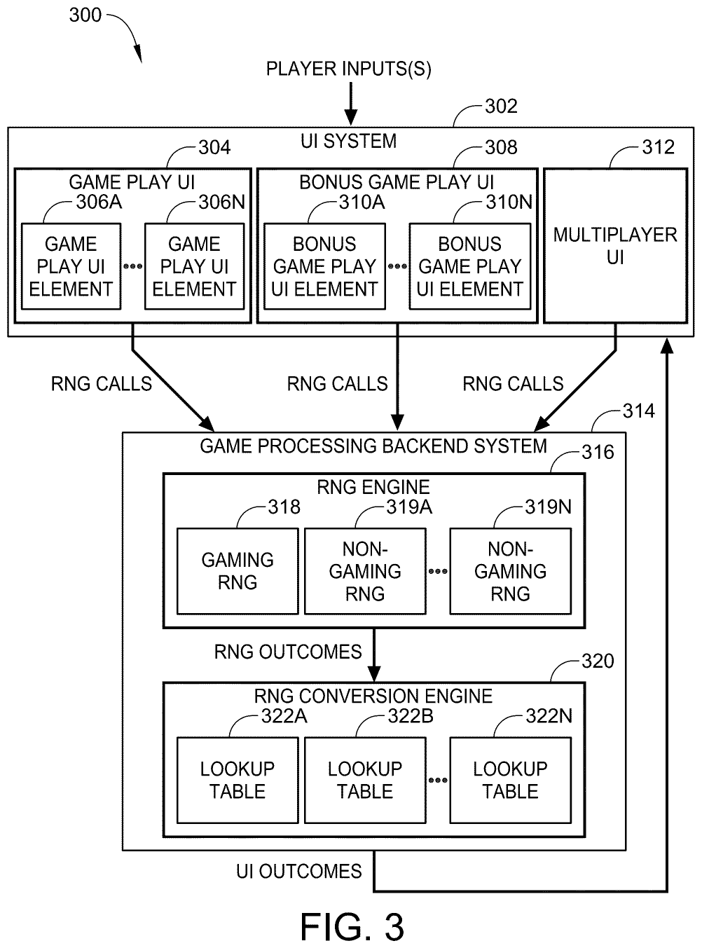

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

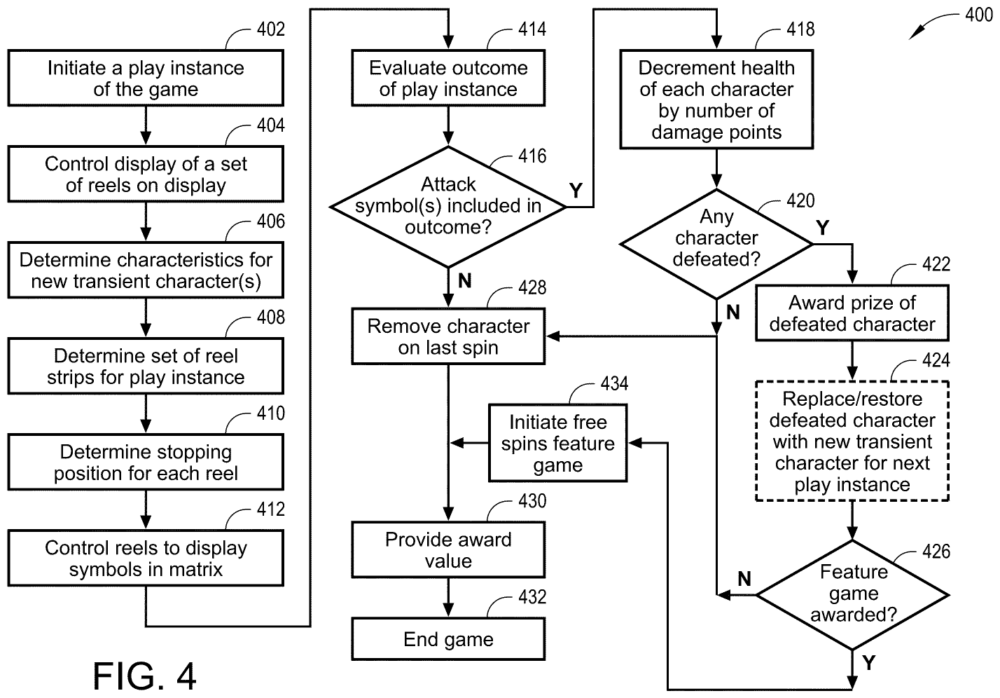

FIG. 4 is a flow chart of an exemplary process 400 for executing electronic game play for display on a gaming device. The process 400 may be implemented by a server (e.g., server 106) and/or a gaming device (e.g., gaming devices 104A-104X in FIG. 1, and/or gaming device 200 and/or mobile gaming device 256 and/or EUDs 264a-c in FIG. 2), as examples. For instance, in an electronic gaming device, a game controller (e.g., game controller 202) includes one or more processors 204 operatively coupled to memory 208. The memory 208 can store one or more game programs 206 that provide program instructions and/or data for carrying out various implementations (e.g., game mechanics) that, when executed by the processor 204, cause the processor 204 to perform certain operations to perform the process 400. Description of the operations of the process 400 being performed by the processor 204 includes implementations where multiple processors 204 are utilized. Moreover, some of the operations of the process 400 may be performed at the gaming device while some of the operations of the process may be performed at the server 106. The numerical ordering/sequencing of the process 400 shown in FIG. 4 and described herein is not intended to limit the process to any particular order of the operations described herein. More broadly, the order of the actions described herein for the process 400 are not limited to any particular order unless expressly stated otherwise or the context clearly indicates otherwise.

At operation 402, the processor 204 initiates a play instance of a game. The play instance may be initiated at operation 402 in response to a player input indicative of a desire to play the game. In some embodiments, prior to initiating the play instance, the processor 204 first receives a selection of a bet option from the player, for example, via buttons 236. In an example, there are a plurality of bet options where bet1<bet2<bet3 etc.

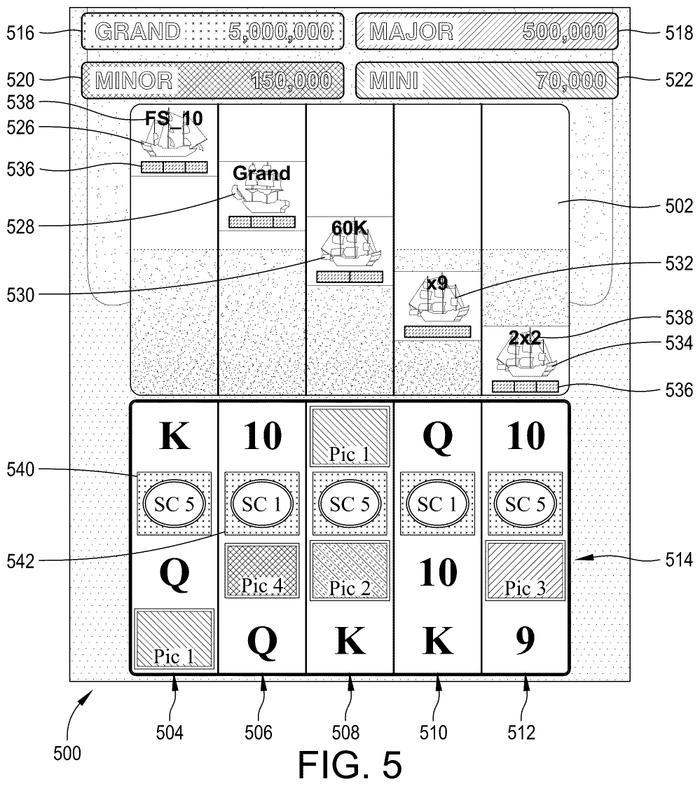

At operation 404, the processor 204 controls a display, such as display 240, to display a plurality of reels in a viewable matrix of symbol positions for the game instance initiated at operation 402. FIG. 5 shows a screen capture 500 of the game play presented on a user interface (UI) 502 (e.g., a UI of the UI system 302, such as game play UI 304) in a base game mode. In the illustrated example, there are five reels 504-512 respectively displayed in one of five columns of a matrix 514 of symbol positions. Each reel 504-512 includes a number of rows viewable in a corresponding number of symbol positions of the matrix 514. The matrix 514 is a 4×5 matrix in the illustrated example, such that each of the five reels 504-512 includes four rows viewable in four symbol positions of the matrix 514, which includes 20 total symbol positions. In other implementations, the matrix 514 may have other configurations and different numbers of symbol positions (e.g., different numbers of columns and respective rows) than shown in the example implementation of FIG. 5. As such, there may be more or fewer than five reels 504-512. Additionally and/or alternatively, each reel 504-512 may include more or fewer than four rows displayed in four symbol positions.

In the example implementation, the game UI 502 is presented on a display, such as display 240 of a mobile or remote device 256 (FIG. 2B), such as a smart phone, tablet, computer, or any other suitable remote device. One or more of the steps of the process 400 may be performed by one or more processors, such as a processor of the remote device and a processor of a central server (e.g., server 106) in communication with the remote device. In other implementations, the game UI 502 is presented on a display of a gaming device located on a casino floor (e.g., gaming devices 104A-104X in FIG. 1, and/or gaming device 200 in FIG. 2A). In some such embodiments, one or more of the steps of the process 400 may be performed locally at the gaming device (e.g., via a game control 202) and/or by a central server (e.g., server 106).

The UI 502 may also display additional graphics associated with the electronic game. For example, the UI 502 may include, in addition to the matrix 514, jackpot meters 516-522, including a grand jackpot meter 516, a major jackpot meter 518, a minor jackpot meter 520, and a mini jackpot meter 522. In some examples, there may be different jackpot meters and/or more or fewer than the four jackpot meters provided by the UI 502. The UI 502 may, in some implementations, also provide one or more metamorphical graphical elements, or metamorphic(s), that transform (e.g., by animation provided on the UI 502) to visually indicate various features of the electronic game that may be triggered during base game play. Any types of metamorphics, objects, symbols, or other graphic elements may be used and provided on the UI 502 to visually inform progress of the electronic game or features of game play. The UI 502 may also provide a credit meter indicating a credit balance of a player of the electronic game, a bet meter, and one or more input buttons (e.g., a SPIN button) that may be selected to initiate a play of the electronic game or provide some other game play input. The elements provided by the UI 502 are by way of example only, and may be displayed on alternative displays such as those described elsewhere herein. The UI 502 may also provide additional graphics other than those illustrated and described.

In the example implementation, five above-reel, transient characters 526-534 are provided by the UI 502. The characters 526-534 are ships or boats in the illustrated example. Other types of characters may be used in other examples. As shown in FIG. 5, each one of the characters 526-534 is displayed adjacent (e.g., above) the matrix 514 in the illustrated example. In particular, each one of the characters 526-534 is displayed adjacent (e.g., above) one of the reels 504-512. The characters 526-534 may be displayed in any suitable location, and in some examples may be displayed on a secondary display separate from the matrix 514.

In the example implementation, each one of the characters 526-534 is associated with one of the reels 504-512, and is displayed adjacent (e.g., above) the reel with which it is associated. Thus, in the illustrated example of FIG. 5, the character 526 is associated with the first reel 504, the character 528 is associated with the second reel 506, the character 530 is associated with the third reel 508, the character 532 is associated with the fourth reel 510, and the character 534 is associated with the fifth reel 512. In the illustrated example, five characters 526-534 are provided by the UI 502 for the five reels 504-512. In other implementations, more or fewer characters 526-534 may be provided. For example, the number of characters 526-534 may vary depending on the number of reels 504-512 used. Additionally and/or alternatively, there may be more characters 526-534 than reels 504-512, or there may be fewer characters than reels.

Each transient character 526-534 includes a prize value and/or other output (indicated by a prize identifier 538) and a health or number of points that needs to be reduced to zero by “attacks” on the character to win the associated prize and/or output (indicated by a health meter 536). Each health point may be displayed in green before it is “attacked” and in red after it is “attacked” to communicate a current status of the transient character associated therewith (e.g., progress toward the output associated with the transient character being provided). The characters 526-534 are “transient” in that they remain displayed for a limited number of spins. In the example implementation, each character 526-534 remains on screen for the same predetermined number of spins or play instances (e.g., five spins or five game play instances). In other implementations, the number of spins may vary for each character 526-534, which may be indicated by a spin counter associated with each character 526-534 that is decremented after each spin (or each game instance). An animation effect may be displayed by the UI 502 after and/or in conjunction with each spin or play instance to indicate the number of spins/play instances remaining for each character 526-534.

In the illustrated example, the processor 204 controls the UI 502 to “move” each character 526-534 (each boat/ship) vertically upward above the associated reel 504-512 one space for a total of five spaces between the matrix 514 and the jackpot meters 516-522 while on screen. Once each character 526-534 has been moved the five spaces (corresponding to five spins/instances on screen), the character 526-534 exits the screen and is replaced by another character 526-534 (determined by the processor 204 as described below). As shown in FIG. 5, the characters 526-534 may be staggered by one space. In other examples, the characters 526-534, or a portion thereof, may move in a non-staggered (e.g., horizontal) arrangement.

While the characters 526-534 are on screen (e.g., before the five spin/play instances for the character 526-534 are played), the number of health points for a character 526-534 may be reduced if attack symbols appear on the reel 504-512 associated with that character. If the number of health points reaches zero while a character 526-534 is on screen, the character 526-534 is defeated and the prize value and/or output for that character (indicated by the prize identifier 538) is awarded. A “defeated” character 526-534 may immediately be restored to full health with the same prize for a subsequent play instance of the game. Alternatively, a defeated character 526-534 may exit the screen and is replaced by another character 526-534 (determined by the processor 204 as described below). A defeated character 526-534 may be restored or replaced regardless of the number of spins/play instances remaining (that is, before the defeated character is on screen for the predetermined number of spins/play instances). Alternatively, in some implementations, a defeated character 526-534 may not be restored or replaced, and remain on screen until the predetermined number of spins/play instances (e.g., five) are played. In the latter implementation, attack symbols that appear on the reel 504-512 associated with the defeated character 526-534 may be considered moot and not have any effect on the character, or could be used for another, non-defeated character 526-534 associated with another one of the reels.

In the example implementation, the prize (e.g., and/or output) associated with each character 526-534, as indicated by the prize identifiers 538, varies between the characters. The prizes for the characters 526-534 include, for example, feature prizes (e.g., free spins), jackpot prizes (e.g., jackpots associated with the meters 516-522), credit value prizes (e.g., what-you-see-is-what-you-get or WYSIWYG values, also described as cash-on reel (COR) values), multiplier values applied to a base game award value, multiplier values paid out on bet level, wild symbols that are applied on the reels 504-512, etc. In the illustrated example of FIG. 5, the character 526 associated with the first reel 504 has a free spins prize, the character 528 associated with the second reel 506 has a grand jackpot prize, the character 530 associated with the third reel 508 has a 60 k credit value prize, the character 532 associated with the fourth reel 510 has a 9× multiplier prize, and the character 534 associated with the fifth reel 512 has a 2×2 wild matrix prize.

Characters 526-534 with relatively higher value prizes (e.g., jackpots, free spins, wild matrices) may also have a greater health (e.g., require a greater number of attacks to be awarded the prize). Characters 526-534 with relatively lower value prizes (e.g., multiplier, lower credit values) may also have a lower health (e.g., require a smaller number of attacks to be awarded the prize).

Referring again to FIG. 4, at operation 406, the processor 204 determines the characteristics (e.g., character type, prize, and health) for each new transient character 526-534 provided by the UI 502 at the initiation of the game play instance. The new transient character(s) 526-534 replace the transient character(s) exiting the screen from the previous game play instance (e.g., the characters that were on screen for the predetermined number of spins and/or characters that were defeated in the previous game play instance). In the example implementation, at the initiation of each game play instance, at least one new character 526-534 is provided by the UI 502 to replace a character, because the staggered formation of the characters is such that one character is constantly on its last spin/play instance and subsequently exits the screen. For example, referring to FIG. 5, at the beginning of the play instance the character 534 is new and replaces a character previously associated with the fifth reel 512 that exited the screen on the last spin. In the subsequent play instance, the character 526 will exit the screen as it will either be defeated or will have used up all its spins on screen (indicated by the character being at the top vertical position between the matrix 514 and the jackpot meters 516-522).

To determine the characteristics for each new transient character (which is character 534 in the illustrated example), the processor 204 may perform one or more lookup operations or “lookups” in one or more lookup tables stored in memory (e.g., the memory 208) to determine the characteristics of that character. Each lookup may be performed by selecting one of a plurality of entries in a lookup table. For one, some, or all the lookups, the entry may be randomly selected by mapping a random number provided by a random number generator (RNG) (e.g., the RNG 212 of FIG. 2A) to one of the entries. Alternatively, for one, some, or all the lookups, the selected entry may be predetermined or selected as part of a regular or irregular interval of entry selections.

In the example implementation, the processor 204 determines the characteristics for each new transient character by performing two lookups at operation 406. The first lookup determines the type of character, which may be selected from one of five prize types that may be further categorized based on award value rank: an extra large (XL) value character type, a large value character type, a medium value character type, a small value character type, and an extra small (XS) value character type. The first lookup may be referred to as a character type lookup. To perform the character type lookup for each character 528, the processor 204 may query a table that includes a list of entries of character types and selects one of the entries. The character type entries may be selected by the processor 204 in sequential order (e.g., in the order listed in the character type lookup table) for each new transient character.

Table 1 below shows an example character type lookup table that may be used in such an implementation, in which the character type entries (which include a prize type and award value rank) are selected by the processor 204 in sequential order corresponding to the order that the characters 526-534 associated with the reels 504-512 exit the screen. Alternatively, in other implementations, a character type entry may be randomly selected for each new transient character, for example, by the processor 204 mapping a random number provided by the RNG 212 to a character type entry from multiple character type entries that may have different weights.

TABLE 1
Character Type Lookup Table

| Reel | Prize Type | Rank |
|---|---|---|
| 1 | Credit | Small |
| 2 | Wild | Medium |
| 3 | Free Spins | Large |
| 4 | Credit | Small |
| 5 | Credit | XS |
| 1 | Wild | XL |
| 2 | Multiplier | Small |
| 3 | Jackpot | Medium |
| 4 | Credit | Small |
| 5 | Credit | Small |
| 1 | Wild | Large |
| 2 | Wild | Medium |
| 3 | Wild | XS |
| 4 | Jackpot | XS |
| 5 | Credit | Medium |

When the character type of the new transient character 534 is determined based on the character type lookup, the processor 204 then determines the characteristics (prize value and health) of the character using a second lookup, also referred to as a characteristic lookup. In the example implementation, the characteristic lookup is performed by mapping a random number provided by the RNG 212 to a characteristic lookup table that includes entries for the prize value and health for the new transient character (e.g., new character 534). Because each entry includes the prize value and health for the new character 534, one characteristic lookup is performed for the new transient character. In other implementations, a separate characteristic lookup may be performed for each characteristic (e.g., separate lookups may be performed for the prize value and the health). In some example implementations, the characteristics for the transient characters 526-534 may include additional and/or other characteristics than prize value and health (e.g., a number of spins for that character). In some such implementations, the other characteristics may be included in the entries of the characteristic lookup table or a separate lookup may be performed to determine the other characteristic(s) for the new character 534.

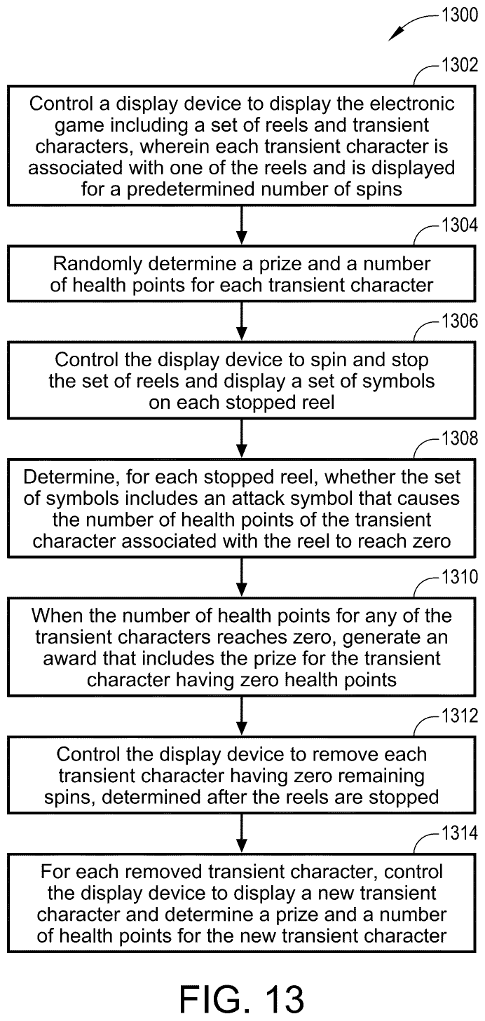

An example embodiment of the lookup tables first associates a prize type and health with transient character, as shown in FIGS. 12A and 12B. An example lookup table 1200 contains prize types and health value ranges associated with options for the new transient character 534. A new transient character 534 is selected either sequentially or randomly from the table 1200, and the prize type and health are selected based on the values in the table 1200. Once the prize type and health are selected, a prize value may be selected according to a characteristic lookup table 1250. Factors such as the prize value and reel number may influence the weight (e.g., the selection odds) of a prize value that may be selected (see also the description of FIGS. 13A and 13B below).

In the example implementation, the characteristic lookup table used for the characteristic lookup depends on the character type selected in the character type lookup. For example, the memory 208 may store different characteristic tables for each prize type and for each award value rank for each prize type. For example, different sets of characteristics tables may be stored in memory for the credit prize type, multiplier prize type, feature or free spins prize type, jackpot prize type, and wild symbols prize type. The characteristic entries in a characteristics table differ depending on the prize type associated with that table. For example, for the credit prize type characteristic tables, the characteristic entries each include a credit value as the prize, whereas for the multiplier prize type characteristic tables, the characteristic entries each include a multiplier value as the prize. Each set of characteristics tables for each different prize type may include a table for each award value rank: an XL value characteristics table, a large value characteristics table, a medium value characteristics table, a small value characteristics table, and an XS value characteristics table. The characteristic entries differ for characteristics tables for the same prize type depending on the award value rank associated with that table. For example, the characteristic entries of the table for the small value credit prize type may have generally smaller credit prize values than the characteristic entries of the table for the large value credit prize type.

As described above, the health characteristic also varies depending on the prize value, and this may be reflected in the characteristic lookup tables of the different prize types and award value ranks. Accordingly, the entries in each characteristic table vary the prize value and health that may be selected by the characteristic lookup. For example, the entries of each characteristic table may have varying prize values. In each characteristic table, the entries having the relatively larger prize values may have a lower weight (lower probability of being selected) and the entries having the relatively lower prize values may have a greater weight (greater probability of being selected). For example, the characteristic lookup table 1250 of FIG. 12B shows example values and weights for a wild shape prize for a wild prize associated with a small value. A medium, large, or XL value table may have higher weights associated with the larger (and more valuable) wild shapes, while a wild shape prize for an XS value table may have higher weights associated with the smaller (and less valuable) wild shapes. The entries and relative probability may vary depending on the implementation of the game. Further, more or fewer lookup tables may be used for the determination of the character type and/or characteristics of each new transient character. For example, the character type lookup may select from more or fewer prize types and/or award value ranks, and the number of characteristic lookup tables may vary depending on the number of possible character types. Notably, the various lookup tables and determinations associated therewith (e.g., based on different RNG outputs, weights in the tables, etc.) are configured to provide the transient characters and outputs associated therewith all while maintaining an RTP for the overall game (e.g., base game, bonus game, etc.).

The processor 204 controls the UI 502 to display each new transient character (character 534 in the example of FIG. 5) and its respective characteristics determined at operation 406. The characteristics are populated in the prize identifier 538 and the health meter 536. As shown in FIG. 5, the characteristics determined for the new transient character 534 is a 2×2 wild symbol prize (which will be described below) and a health of three points. At this stage, the processor may control the UI 502 to move the remaining characters 526-532 on the screen vertically upward one position to indicate that each character has one fewer spin remaining before exiting the screen. The characteristics of these characters 526-532 may have been determined during a previous game instance when they first appeared on the screen and are populated in the health meter 536 and the prize identifier 538.

As shown in FIG. 5, the associated reel, the characteristics, and vertical location (remaining spins) of the remaining characters 526-532 are as follows: the character 526 associated with the first reel 504 has a free spins prize, a health of three points, and is in the topmost vertical position (indicating it has zero remaining spins and will exit the screen after this game instance); the character 528 associated with the second reel 506 has a grand jackpot prize, a health of three points, and is in the second topmost vertical position (indicating it has one remaining spin after this game instance); the character 530 associated with the third reel 508 has a 60 k credit value prize, a health of two points, and is in the third topmost vertical position (indicating it has two remaining spins after this game instance); the character 532 associated with the fourth reel 510 has a 9× multiplier prize, a health of one point, and is in the second bottommost vertical position (indicating it has three remaining spins after this game instance); and the character 534 associated with the fifth reel 512 has a 2×2 Wild prize (e.g., indicating that a 2×2 Wild matrix will be added (e.g., and/or overlaid)) on the reels, and is in the bottommost vertical position (indicating it has four remaining spins after this game instance).

The prize type and/or award value rank of each transient character 526-534 may be indicated by the boat or ship used for the character, and this may also be determined at operation 406 when the character enters the screen. For example, bigger boats or ships may be used for larger prize types and/or award values and smaller boats or ships may be used for smaller prize types and/or award values. Alternatively, the boat/ship used as a transient character may be independent of the character type selected, such that the same boat/ship character could be any prize type or any award value rank depending on the determination at operation 406. In some examples, the boat/ship used as each new transient character may be determined by another lookup. In some examples, the boat/ship used as each new transient characters may be used at predefined (regular or irregular) intervals.

In the example implementation, at operation 408, the processor 204 determines a set of reel strips for the reels 504-512 that will be used for the game play instance. The processor 204 may determine the set of reel strips based on a lookup operation performed using a lookup table stored in memory (e.g., the memory 208) to select one of a plurality of reel strip set entries in the lookup table. The reel strip set entry may be randomly selected by mapping a random number provided by a random number generator (RNG) (e.g., the RNG 212 of FIG. 2A) to one of the entries. Alternatively, the selected entry may be predetermined or selected as part of a regular or irregular interval of entry selections. In other implementations, the set of reel strips may be predetermined and changes at predefined (regular or irregular) intervals or may not change between instances of the game.

As described in further detail below, attack symbols 540 or 542 may appear in the matrix 514 and operate against or attack the characters 526-534 depending on the respective reel 504-512 on which they land. In particular, each attack symbol 540 or 542 landing on a reel 504-512 decrements the number of health points of the character 526-534 associated with that reel. A character 526-534 is defeated, and the associated prize is awarded, when enough attack symbols 540 or 542 land when that character is on screen to reduce its health meter 536 to zero. The sets of reel strips stored in memory may include different probabilities that one or more attack symbols 540 or 542 will land in the matrix 514 when the set of reel strips is selected at operation 408. For example, some of the sets of reel strips may include a greater number of instances of attack symbols 540 or 542 than some others of the sets of reel strips. This may increase the randomness of the game and/or facilitate greater control of the hit rate of landing attack symbols 540 or 542 to defeat the characters 526-534 as described further below. Notably, attack symbols other than the attack symbols 540, 542 shown are envisioned (e.g., associated with more or less “attacks”).

At operation 410, the processor 204 determines a stopping position for each of the reels 504-512 (FIG. 5) for display of a combination of symbols in the matrix 514. During the game play instance initiated at 402, symbols may be selected (e.g., such as from the reel strips associated with the reels 504-512 selected at operation 408) and displayed in the symbol positions within the matrix 514. Each reel strip associated with one of the reels 504-512 may include a plurality of symbols arranged in a vertical column. In the example embodiment, the reel game uses virtual reel strips for the reels 504-512. The reel strips may include various basic symbols (e.g., “A”, “K”, “Q”, “J”, “10”, “9”, picture symbols), as well as feature symbols. The feature symbols may, in some examples, include bonus game symbols and/or cash on reel (COR) symbols. The bonus game symbols may trigger a bonus game when a triggering number appears in the matrix 514. The cash-on-reel (COR) symbols correspond to credit values that may be awarded for each COR symbol appearing in the matrix 514. A number of symbols of each reel, corresponding to the number of rows of the matrix 514, is displayed in a column of symbol positions within the matrix during game play. In some implementations, a separate reel, e.g., an independent reel, may be utilized for each symbol position of the matrix 514.

In the example implementation, the feature symbols included on the reel strips for at least some of the reels 504-512 include attack symbols (e.g., the attack symbols 540 and 542) that, when displayed on the reels 504-512 in the matrix 514, operate against or attack the characters 526-534 to reduce the number of health points indicated by the health meters 536. In the example implementation, each attack symbol attacks the character 526-534 associated with the reel 504-512 on which the attack symbol lands. In other example implementations, each attack symbol that appears in the matrix 514 may operate against each character 526-534, regardless of reel association.

The attack symbols (e.g., the attack symbols 540 and 542) appearing on a reel 504-512 decrement the health meter 536 of the character 526-534 associated with that reel by a certain amount of points. The number of health points decremented by the attack symbols, or the damage that the attack symbols cause, may vary between different types of attack symbols. In the example implementation, the reel strips include two types of attack symbols—single attack symbols 542 (corresponding to one health point of damage to the respective character), and quintuple attack symbols 540 (corresponding to five health points of damage to the respective character). In other implementations, any suitable number of different types of attack symbols may be used. The different types of attack symbols (e.g., attack symbols 540 and 542) may be indicated by graphical elements (e.g., identifiers or words on the symbol) and/or by different types of symbols (e.g., different pictures) used for the different attack symbols. In the illustrated example, the attack symbols are each shown as cannonballs. As shown in FIG. 5, the single attack symbols 542 and the quintuple attack symbols 540 that are included on the reel strips are differentiated by words that identify the attack symbol type.

In the example implementation, each instance of an attack symbol on the reel strips selected at operation 408 is a dynamic symbol. That is, the type of attack symbol (e.g., a single attack symbol 542 or a quintuple attack symbol 540) may be determined by an additional lookup in one or more attack symbol lookup tables. This may be determined separate from the stopping position determination at operation 410. For example, the processor 204 may determine the type of attack symbol to be included on a reel 504-512 when, at operation 410, the processor 204 determines a stopping position for the reel that results in an attack symbol being displayed. The processor 204 may determine the type of attack symbol to be displayed on a reel 504-512 based on a random selection from the corresponding attack symbol lookup table. In some example implementations, the processor 204 may determine the type of attack symbol by mapping a random number provided by the RNG 212 to an attack symbol lookup table. The attack symbol lookup table may be the same for each reel or different attack symbol lookup tables may be used for the different reels. In other implementations, the attack symbols on one or more of the reel strips may be static (e.g., each instance of an attack symbol on a reel strip is either a single or quintuple attack symbol and does not change between game instances). In such embodiments, an additional lookup to determine the types of attack symbols to display on a reel 504-512 may not be necessary.

Based on the stopping positions for the reels 504-512 determined at operation 410, the UI 502 causes display of a number of symbols of each reel, corresponding to the number of rows in the respective column, within the reel matrix 514 during the game play instance. To display symbols from a reel within the matrix 514, the processor 204 may control, at operation 412, the UI 502 to simulate rotation or spinning of one or more of the reels 504-512 within a respective column. When a respective reel is simulated to halt or stop within an associated column, one or more symbols may be displayed from the reel strip in the symbol positions of the column. Alternatively, in implementations in which independent reels are used, each reel may be controlled to independently spin and stop and display a symbol in its respective symbol position in the matrix 514. The symbols displayed after spinning and stopping each reel in a respective column or symbol position of the reel matrix 514 may be referred to herein as a “reel outcome” or a “base reel game outcome” or a “base game outcome.” More broadly, an “outcome” of a reel game refers to the symbols displayed in a reel matrix after reels are spun and stopped. Thus, a rotation and stopping of the reels 504-512 (also referred to herein as a “spin and stop sequence”) may be simulated by the UI 502 within the columns of the matrix 514 to cause a reel outcome, including a plurality of symbols, to be displayed from the associated reel strips within the matrix. Each play of the reel game may include one or more reel game outcomes, that is, each play of the reel game may include a single spin and stop sequence of the reels 504-512 or multiple spin and stop sequences.

Before the symbols are displayed at operation 412 based on the stopping positions of the reels 504-512 determined at operation 410, the types of the attack symbols may be determined as described above in implementations where the attack symbols included on the reel strips are dynamic. In the example outcome of FIG. 5, a dynamic attack symbol appears on each reel 504-512 (based on the determined stopping positions) and the attack symbols for display are determined as follows: the attack symbol on the first reel 504 is a quintuple attack symbol 540, the attack symbol on the second reel 506 is a single attack symbol 542, the attack symbol on the third reel 508 is a quintuple attack symbol 540, the attack symbol on the fourth reel 510 is a single attack symbol 542, and the attack symbol on the fifth reel 512 is a quintuple attack symbol 540. Each attack symbol type for the dynamic attack symbols may be determined as described above by a lookup operation using one or more attack symbol lookup tables. A single lookup operation may be utilized for all the attack symbols, or a separate lookup may be performed for each attack symbol. One or multiple attack symbol lookup tables may be used. Where multiple attack symbol lookup tables are used, a different attack symbol lookup table may be associated with each reel 504-512.

Following operation 412, symbols are displayed on each of the reels 504-512 within the matrix 514, forming an outcome of a game instance that may then be evaluated. Accordingly, at operation 414, the processor 204 evaluates the outcome (e.g., the symbols displayed within the matrix 514) for winning symbols and/or symbol combinations that provide an award or another game feature to the player. Any win conditions within the matrix 514 can be detected by the processor 204 and any win amounts can be awarded to the player (e.g., credited to the player's credit balance). The win conditions may be defined according to a “ways” approach or may be defined as pay lines or win lines. In the example implementation, win conditions may be defined as pay lines (also called win lines) across at least a portion of the reel matrix 514. When a certain combination of symbols appears along a pay line, a win amount corresponding to that combination of symbols and that pay line may be awarded. Win amounts can vary according to the combination of symbols and according to the particular pay line along which the combination of symbols appears. Win amounts are typically determined according to a pay table, where the pay table comprehends the various combinations of symbols and pay lines that may occur (e.g., the win conditions). In other implementations, the win conditions are defined according to a ways approach, in which symbols displayed at symbol display positions within one of the columns of the matrix 514 can be used to form symbol combinations (one symbol per reel in a combination) with the symbols displayed at designated symbol display positions of each of the other columns of the matrix 514. For example, in the example matrix 514 in which there are five reels 504-512, and four symbol display positions for each reel 504 and 506 and four symbol display positions for each reel 508-512, each possible path through the symbol display position(s) of the respective reels may provide a way to win. The total number of ways to win in the matrix 514 may be determined by multiplying the number of active display position(s) of each reel 504-512, where the active display position(s) for a reel are all display positions in the matrix 514. As a result, there 4×4×4×4×4=1024 ways to win for the matrix 514. The win amount for a round of play may be a fraction of an amount wagered for that round of play for certain win conditions. For other win conditions, the win amount may be much larger than the amount wagered.

The evaluation at operation 414 includes determining whether any feature symbols are displayed on the reels 504-512 that may provide certain awards and/or unlock certain features of the game once all the reels 504-512 have spun and stopped. For example, the processor 204 may determine whether any symbols that are treated as “wild” symbols for the purposes of evaluating the outcome at operation 414 are displayed in the matrix 514, such that a wild symbol may be treated as one or more different symbols depending on the pay line being assessed. The processor 204 may additionally and/or alternatively determine whether any bonus game symbols and/or COR symbols are displayed in the matrix 514. On the basis of this evaluation, the processor 204 may determine the award value associated with the combination of symbols displayed within the matrix 514 and/or whether a bonus game is triggered.

For the purposes of evaluating the symbols within the matrix 514 at operation 414, the attack symbols 540 and 542, if any, that appear on the reels 504-512 may be treated as “blocking” symbols. That is, any symbol position within the matrix 514 that includes an attack symbol 540 or 542 may be blocked or precluded from forming a winning symbol combination. For example, in the outcome shown in the screen capture 500 of FIG. 5, the second to topmost row or symbol position of each reel 504-512 that includes an attack symbol 540 or 542 is precluded from forming a way to win (under a ways approach) or a winning pay line.

Based on the evaluation at operation 414, the processor 204 determines at operation 416 whether any attack symbols 540 or 542 are displayed within the matrix 514 on the reels 504-512. For each reel 504-512, when one or more attack symbols 540 or 542 are displayed on that reel, the processor 204 controls, at operation 418, the UI 502 to decrement the health meter 536 of the character 526-534 associated with that reel by the number of health points corresponding to the number of damage points associated with the attack symbols on that reel. The processor 204 may also control the UI 502 to provide an animation effect (e.g., between attack symbols 540, 542 and characters 526-534) to visually inform the player that the attack symbols 540 or 542 operate against the characters 526-534 and result in the decremented health meters 536. For example, the processor 204 may control the UI 502 to display the attack symbols 540 and 542 firing a cannon at the associated boat/ship characters 526-534. As described above, while each attack symbol 540 and 542 operates against the character 526-534 associated with the reel 504-512 in which the attack symbol lands in the example implementation, in some other implementations, each attack symbol may operate against each character. In some such implementations, the combined total damage points of all attack symbols appearing in the matrix 514 may be applied against the health meter 536 of each character 526-534.

At operation 420, when attack symbol(s) 540 or 542 appear on one or more of the reels 504-512 and attack one or more of the associated characters 526-534, the processor 204 determines whether any of the characters are “defeated,” that is, whether the health meter 536 of any character is reduced to zero based on a “hit.” If no characters 526-534 are defeated, then none of the prizes are awarded. If one or more of the characters 526-534 are defeated, the processor 204 at operation 422 determines and awards the prize(s) (indicated by the prize identifier 538) associated with the defeated character(s) to the player. The awarded prize(s) on the defeated characters may be paid out at operation 422 before any of the win conditions in the matrix 514 (e.g., line pays) are paid out at operation 430. Alternatively, the awarded prize(s) on the defeated characters may be paid out at operation 422 at the conclusion of the game play instance in conjunction with any payout for win conditions (e.g., line pays) in the matrix 514 (operation 430).

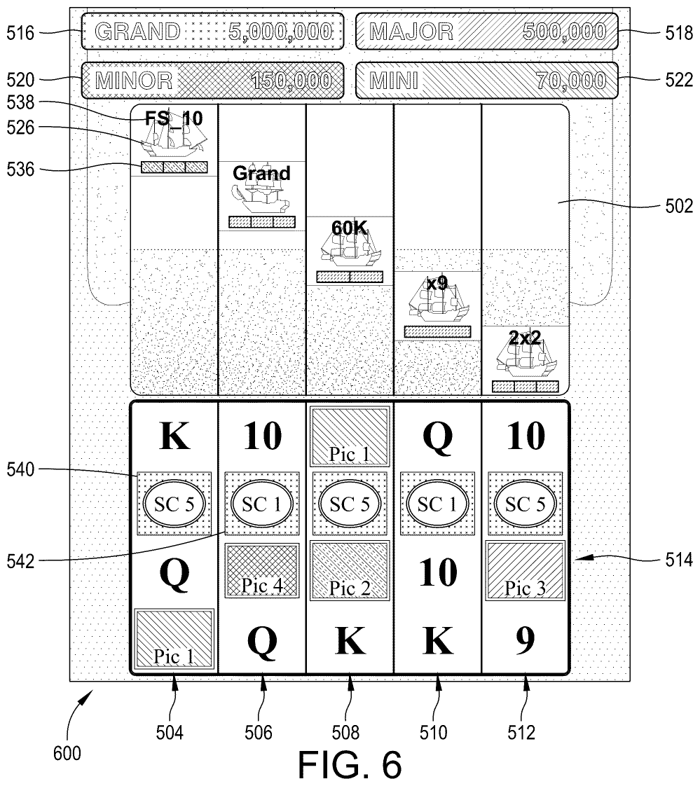

As described above, in the illustrated example, an attack symbol 540 or 542 appears on each reel 504-512. As a result, each character 526-534 is attacked or hit, and an animation effect or some other visual indication may be displayed by the UI 502 to visually inform the player the damage caused to each character and whether the character has been defeated. FIGS. 6-10 are screen captures 600-1000 showing the damage to each character as displayed by the UI 502 following the outcome of FIG. 5.

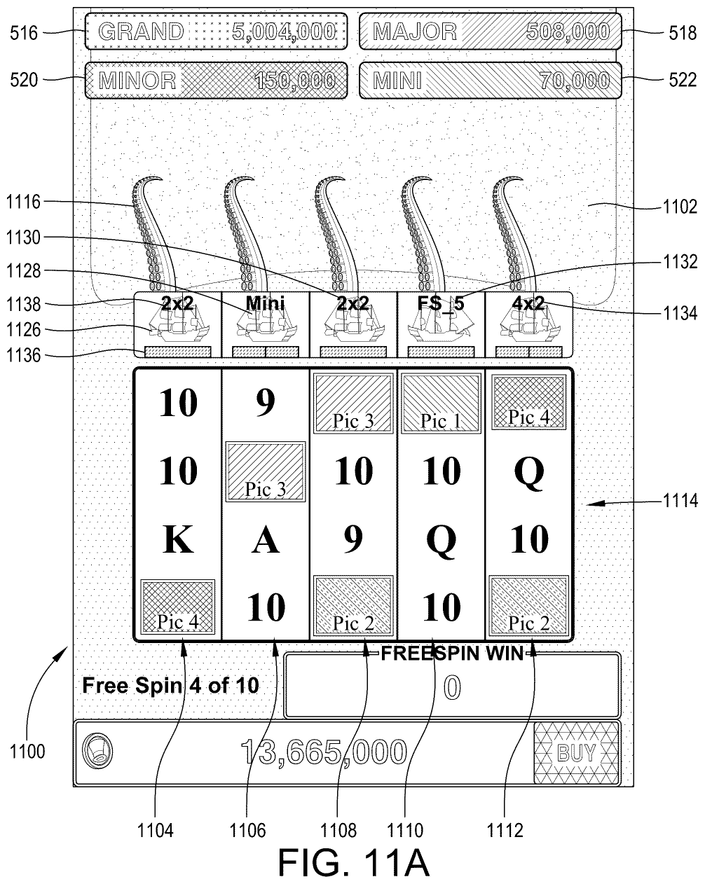

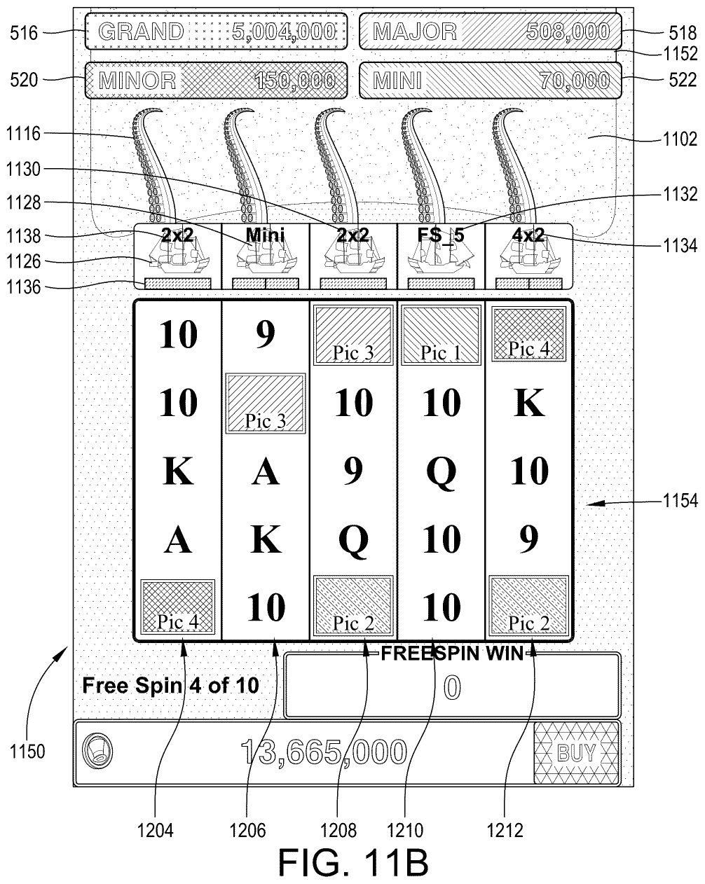

As shown in the screen capture 600 of FIG. 6, the quintuple attack symbol 540 on the first reel 504 eliminates the three points of health for (and thus defeats) the character 526. The health meter 536 of the character 526 is reduced to zero and the free spins prize indicated by the prize identifier 538 is awarded by triggering a free spins feature game (this will be described in further detail below with reference to FIGS. 11A and 11B). In some embodiments, the free spins may be provided in the base game (e.g., shown in FIGS. 6-10) alternatively and/or additionally to being applied to a feature game.

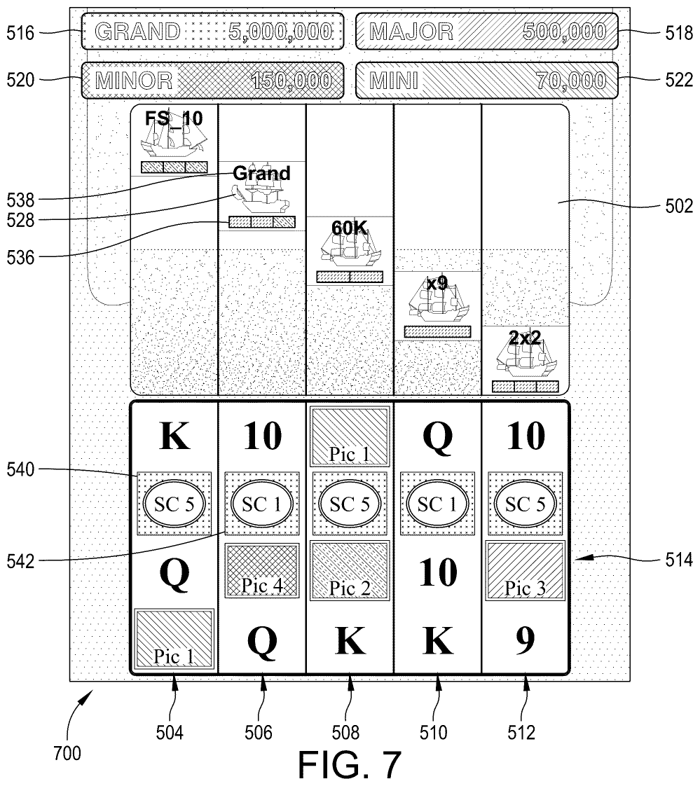

As shown in the screen capture 700 of FIG. 7, the single attack symbol 542 on the reel 506 eliminates one of the three points of health for the character 528. The health meter 536 of the character 528 is reduced by one. Because the character 528 still has two remaining health points, indicated by the meter 536, the character 528 is not defeated and the grand jackpot prize indicated by the prize identifier 538 is not awarded. For subsequent plays of the game, the health meter 536 of the character 528 remains at the reduced number of health points (e.g., 2 points as shown in FIG. 7) until another attack symbol 540 or 542 lands on the reel 506 to further decrement the number of health points or defeat the character 528 (at which point the grand jackpot prize is awarded), or until the character 528 exits the screen once the number of spins for that character is completed.

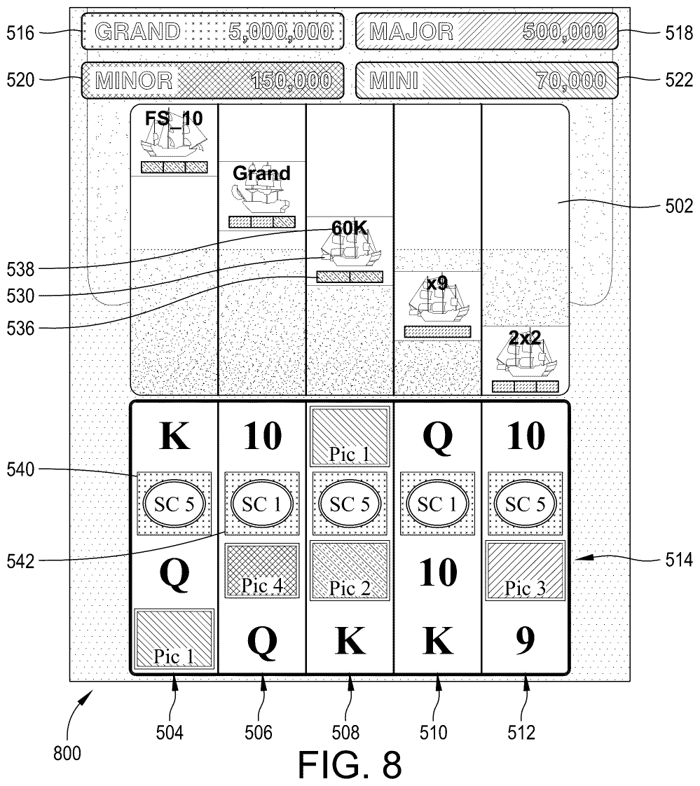

As shown in the screen capture 800 of FIG. 8, the quintuple attack symbol 540 on the third reel 508 eliminates the two points of health for and defeats the character 530. The health meter 536 of the character 530 is reduced to zero and the 60 k credit value indicated by the prize identifier 538 is awarded. The 60 k credit value may be awarded at operation 430 in combination with any award value resulting from win conditions in the matrix 514, an award resulting from the free spins game (described below with reference to FIGS. 11A and 11B) triggered from the defeated character 526, and/or any award from the remaining characters 532 and 534 described below.

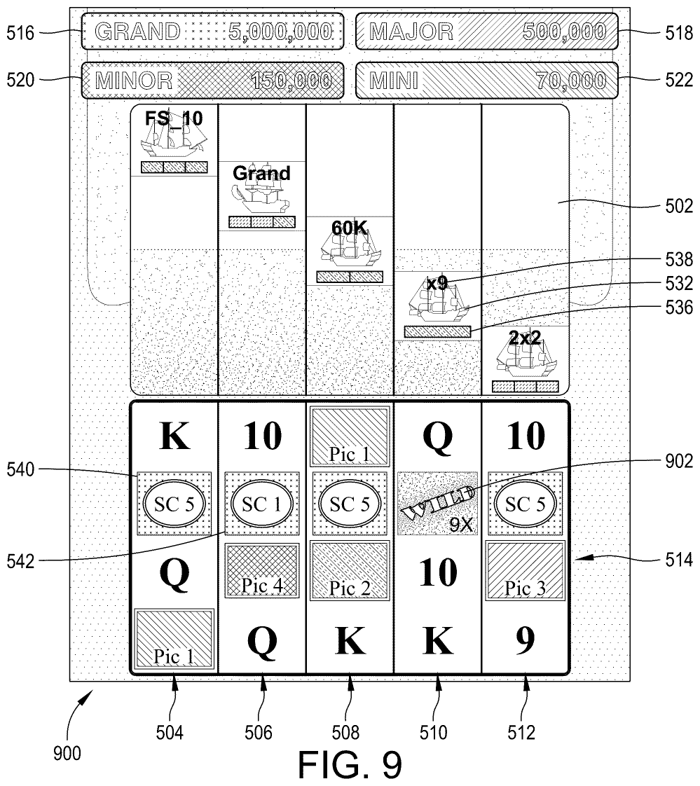

As shown in the screen capture 900 of FIG. 9, the single attack symbol 542 on the fourth reel 510 eliminates the one point of health for and defeats the character 532. The health meter 536 of the character 532 is reduced to zero and the 9× multiplier indicated by the prize identifier 538 is awarded. In the example implementation, multiplier prizes for defeated characters 526-534 are awarded by replacing the attack symbol 540 or 542 that defeats the character with a wild symbol that includes the indicated multiplier value. In the example implementation, multiplier prizes may range from 2× to 10× depending on the award value rank for the multiplier prize type. As shown in FIG. 9, the single attack symbol 542 on the fourth reel 510 is replaced by a 9× multiplier wild symbol (indicated at 902), corresponding to the 9× multiplier indicated by the prize identifier 538 of the defeated character 532. The wild symbol 902 may be evaluated as a “wild” for the purpose of determining win conditions in the matrix 514. In other words, the blocking attack symbol 540 is converted to a wild symbol 902 that is able to form a winning symbol combination in the respective symbol position. The 9× multiplier may be applied to increase the award value of any winning symbol combination that includes (is formed in part by) the wild symbol 902. Alternatively, the 9× multiplier may be applied to the total award value resulting from all win conditions in the matrix 514. This increased award value may be awarded at operation 430.

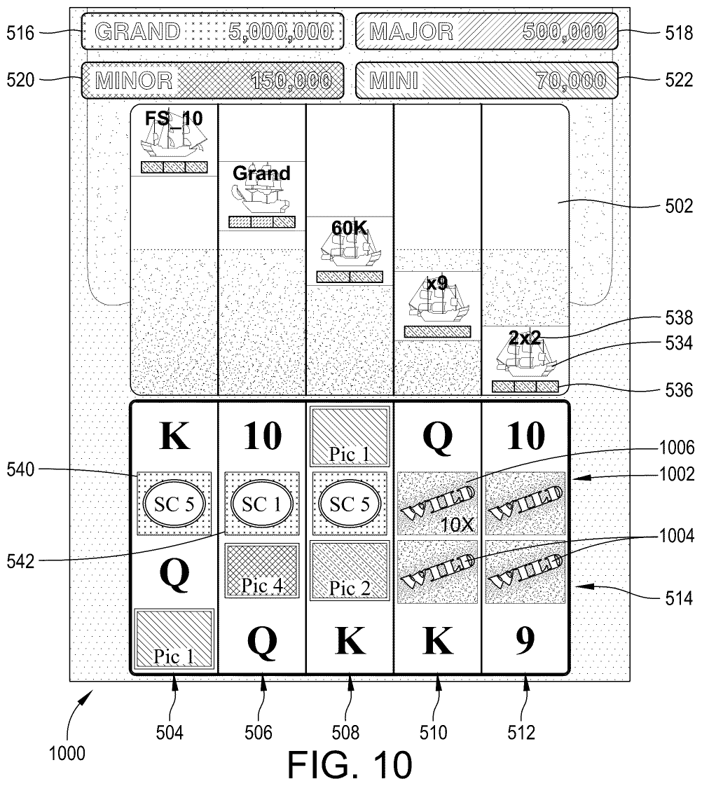

As shown in the screen capture 1000 of FIG. 10, the quintuple attack symbol 540 on the fifth reel 512 eliminates the three points of health for and defeats the character 534. The health meter 536 of the character 534 is reduced to zero and the 2×2 wild matrix prize indicated by the prize identifier 538 is awarded. In the example implementation, wild symbol prizes for defeated characters 526-534 are awarded by replacing the attack symbol 540 or 542 that defeats the character with a wild symbol or a wild symbol matrix having the dimensions indicated by the prize identifier 538. In the example implementation, wild symbol matrices may range from 3×1, 2×2, 3×2, 2×3, 1×4, 4×1, 4×2, 2×4, 3×4, 4×3, and 3×3 depending on the award value rank for the multiplier prize type.

As shown in FIG. 10, the quintuple attack symbol 540 on the fifth reel 512 is replaced by the 2×2 wild symbol matrix (indicated at 1002), corresponding to the 2×2 wild symbol matrix indicated by the prize identifier 538 of the defeated character 534. Symbol positions in the matrix 514 directly or indirectly adjacent to the replaced attack symbol are also populated with wild symbols 1004 to complete the matrix 1002 when wild symbol matrix prize is awarded. As shown in FIG. 10, the symbol positions in the two middle rows of the reels 510-512, including the symbol position in the second to topmost row of the fifth reel 512 that includes the replaced attack symbol, are populated with wild symbols 1004 to complete the matrix 1002. The default for forming a wild symbol matrix 1002 when a wild symbol matrix prize is awarded may be to arrange the replaced attack symbol at the lower left position of the matrix 1002 and re-configure the matrix from the default if some of the wild symbols 1004 would otherwise be outside the matrix 514. Thus, in the illustrated example of FIG. 10, the wild symbol matrix 1002 is rearranged to position the replaced wild symbol in the middle row and rightmost column of the matrix 1002 to ensure that all wild symbols 1004 of the matrix 1002 are within the matrix 514.

Each wild symbol 1004 of the matrix 1002 is evaluated as a “wild” for the purpose of determining win conditions in the matrix 514. When the wild symbol matrix 1002 overlaps another wild symbol that otherwise appears in a symbol position in the matrix 514 (whether from the outcome determined from the stopping positions of the reels 504-512 or from another defeated character during the game play instance), that wild symbol may be upgraded to a +1× multiplier wild symbol. In the illustrated example, the 9× multiplier wild symbol 902 (FIG. 9) awarded from the defeated character 532 is included in the wild symbol matrix 1002 and is upgraded to a 10× multiplier wild symbol 1006. Any award value from win conditions formed by the wild symbols 1004 within the matrix 514, including the upgraded wild symbol 1006, may be awarded at operation 430.

At operation 424, the processor 204 controls the UI 502 to restore or replace any character 526-534 defeated in the game play instance with another transient character 526-534 for the next play instance (next spin) of the game. In the example implementation, the processor 204 may restore the defeated character, that is, replaces the defeated character with the same character type (including the same prize type and award value rank) having the same characteristics (health points and prize). In this implementation, the defeated characters 524 and 530-534 are restored, that is, replaced by the same characters having the same health meter 536 and prize identifier 538. In other implementations, the processor 204 may determine another character type (award value type) and characteristics (e.g., health points and prize) of the new character that replaces a defeated character using the lookups described above for the operation 406.

For example, when one or more of the characters 528 are defeated, the processor 204 may determine the type and characteristics for each new/replacement character 928 provided by the UI 502 by performing a character type lookup in the character type lookup table (e.g., Table 1, FIG. 12A) and a characteristics lookup using the characteristics lookup table associated with the selected character type (prize type and award value rank, e.g., FIG. 12B). In other implementations, a defeated character 526-534 may remain on screen until the predetermined number of spins/play instances (e.g., five) are played.

At operation 426, which may be performed before, after, or concurrently with the determination at operation 420 or the subsequent operations 422 and 424 described above, the processor 204 determines whether a defeated character 526-534 triggers a feature game (e.g., a free spins feature game). In the illustrated example, a free spins feature game is triggered because the character 526 is defeated and awards a free spins prize. When the free spins feature game is triggered, the processor 204 may control the UI 502 to display an animation effect or transition screen to visually inform the player that the free spins feature game is triggered. The processor 204 may then initiate the free spins game in a feature game mode at operation 434. In the example implementation, the free spins game initiated at operation 434 is initiated after all other awarded prize(s) on the defeated characters are paid out at operation 422 and all other win conditions (e.g., line pays) in the matrix 514 are paid out at operation 430. In other implementations, the free spins game may be initiated before operation 422 and/or before operation 430.

FIG. 11A shows a screen capture 1100 of an example free spins feature game that may be initiated at operation 434 when a defected character (e.g., the character 526) has the free spins prize. The processor 204 may control display of the free spins game using a feature UI 1102 (e.g., a bonus game play UI 308 shown in FIG. 3). The example free spins game of FIG. 11A includes display, by the UI 1102, of feature reels 1104-1112 arranged in a viewable matrix 1114 of symbol positions. The reels 1104-1112 may be similar to the reels 504-512 for the base game, and the matrix 1114 may have a 4×5 configuration similar to the base game matrix 514. The configuration of the matrix 1114 may vary, for example, the matrix 1114 may include more or fewer symbol positions (e.g., more or fewer rows and/or more or fewer columns). The UI 1102 also provides the jackpot meters 516-522 described above for the base game UI 502. A feature game metamorphic 1116 is also provided by the UI 1102. The metamorphic is a kraken in the illustrated example, with its tentacles appearing above the matrix 1114. The UI 1102 may cause transformation or animation of the metamorphic 1116 to visually indicate various features of the free spins game, including awards and bonuses or upgrades, that may be unlocked during play of the free spins, including those described below.

In the example implementation, the free spins feature game provides 10 free spins to the player. The number of remaining free spins may be provided in a spin counter (not shown) on the UI 1102, and the UI 1102 may decrement the spin counter by 1 after each spin of the free spins game. In some examples, the number of spins provided during the free spins game may vary. For example, more or fewer than 10 free spins may be provided. In some examples, the number of free spins may be determined based on the lookup operation performed by the processor 204 for the free spins prize type (e.g., the number of free spins may vary between award value ranks of the free spins prize type).

When the free spins game is initiated at operation 434, the processor 204 may control the UI 1102 to display, in conjunction with the reels 1104-1112 in the matrix 1114 and the metamorphic 1116, feature characters 1126-1134. The feature characters 1126-1134, like the characters 526-534 of the base game, are each associated with one of the reels 1104-1112, and five feature characters are provided in the example implementation. More or fewer feature characters 1126-1134 may be provided and, in some examples, each feature character 1126-1134 may be associated with more than one of or all the reels 1104-1112. Like the transient characters 526-534 of the base game, the feature characters each include a prize or award value (indicated by a prize identifier 1138) and a health or number of points that needs to be reduced to zero by “attacks” on the character to win the associated prize (indicated by a health meter 1136). Unlike the transient characters of the base game, the feature characters 1126-1134 are static and remain on screen for the entirety of the free spins game. In other examples, the feature characters 1126-1134 may be transient and exit the screen after some number of spins that is smaller than the total number of spins provided for the free spins game.

When the free spins feature game begins, the processor 204 determines the health points and prize for each feature character 1126-1134. This may be determined by a similar character type lookup (prize type and award value rank) and characteristics lookup for each of the feature characters 1126-1134 as described above for the operation 406 to determine the characteristics of the base game characters 526-534. In some implementations, a single lookup or set of lookups may be performed to determine the prize and health points for each of the feature characters 1126-1138 at the beginning of the free spins feature game. For example, a character type lookup and characteristics lookup may be performed for all the feature characters 1126-1134 at once. The lookup(s) may be performed using the same or different lookup tables used to determine the characteristics of the base game characters 526-534. The prizes that are available for the feature characters 1126-1134 may be the same as or different from the prizes available for the base game characters 526-534. In the example implementation, the prizes for the feature characters 1126-1134 include, for example, additional spins or a free spin reset, jackpot prizes, credit value prizes (e.g., what-you-see-is-what-you-get or WYSIWYG value), multiplier values (e.g., multiplier wild symbols), wild symbols or wild symbol matrices, etc. The available prizes for the feature characters 1126-1134 may have similar values or relatively larger values than the available prizes for the base game characters 526-534.

The processor 204 controls the UI 1102 to display the prize and health points determined for each feature character 1126-1134 in the respective prize identifiers 1138 and health meters 1136. In the illustrated example of FIG. 11A, the feature character 1126 associated with the first reel 1104 has a 2×2 wild matrix prize, the character 1128 associated with the second reel 1106 has a mini jackpot prize, the character 1130 associated with the third reel 1108 has a 2×2 wild matrix prize, the character 1132 associated with the fourth reel 1110 has a +5 spins prize (which corresponds to five additional spins of the free spins game if awarded), and the character 1134 associated with the fifth reel 1112 has a 4×2 wild matrix prize. As described above for the base game characters 526-534, the feature characters 1126-1134 that have relatively higher value prizes (e.g., jackpots, free spins, wild matrices) may have a greater health (e.g., require a greater number of attacks to be awarded the prize), and characters 1126-1134 with relatively lower value prizes (e.g., multiplier, lower credit values) may have a lower health (e.g., require a smaller number of attacks to be awarded the prize).

When each feature character 1126-1134 is populated with its determined characteristics, the spins of the free spins game are played. At the conclusion of each spin, an outcome is displayed in the matrix 1114 based on stopping positions determined for the reels 1104-1112 and their associated reel strips. The same or a different set of reel strips may be used for the feature reels 1104-1112 as used for the base game reels 504-512. Each free spin outcome may be evaluated for win conditions (e.g., using a paylines approach or a ways approach) as described above for the base game. Attack symbols (e.g., attack symbols 540 or 542) may appear on the reels 1104-1112 during a free spin outcome, and operate against the feature characters 1126-1134 as described above for the base game characters 526-534. When a feature character 1126-1134 is defeated, the associated prize may be awarded immediately or at the conclusion of the free spins game. A defeated character 1126-1134 may be replaced as described above during the free spins game or may remain defeated (and is not replaced) for the remainder of the free spins game.

Additional awards, features, or upgrades may be available during the free spins game that are not available during base game play. For example, the reel strips used for the feature reels 1104-1112 may include a kraken symbol (not shown) that may appear on any of the reels 1104-1112, and the appearance of the kraken symbol may automatically defeat one or more of the feature characters 1126-1134. Multiple different types of kraken symbols may be used, and the number of characters 1126-1134 that are automatically defeated may vary depending on the kraken symbol that appears. For example, depending on the kraken symbol type that appears in the matrix 1114, any number between 2 to 5 (all) of the characters 1126-1134 may be defeated. An animation effect may be displayed in conjunction with the appearance of a kraken symbol (e.g., the tentacles of the kraken metamorphic 1116 may be controlled by the UI 1102 to attack the defeated characters 1126-1134).

FIG. 11B is a screen capture 1150 depicting an expanding reels feature (“star surge feature”) that may be triggered during game play. This feature/upgrade may be triggered based on any suitable trigger condition (e.g., an RNG outcome generated in response to some condition satisfied either during the base game or feature game play). Whether the star surge feature is triggered may be determined at operation 426, for example, or this feature may be triggered and initiated before or after operation 426 during implementation of the process 400. The star surge feature may be a free spins feature game, similar to the free spins game shown in FIG. 11A, with an expanded reel upgrade. As shown in FIG. 11B, the processor 204 may control display of the star surge feature using a feature UI 1152 (e.g., a game play UI 304 or a bonus game play UI 308 shown in FIG. 3). As shown in FIG. 11B, the UI 1152 controls the matrix 514 or 1114 to expand from a 4×5 configuration to a matrix 1154 having a 5×5 configuration (such that the number of rows or symbol positions for each reel 1204-1212 increases by one). The matrix 1154 may expand to any suitable configuration in the expanding reels upgrade, including by increasing the number of rows for each reel and/or the number of reels used.

As a result, the potential to satisfy win conditions (either under a paylines or a ways approach) increases in the matrix 1154 during this upgrade. The processor 204 controls the UI 1152 to display a metamorphic and characters above the matrix 1154, as described above for base game and free spins game play. In the example implementation, the UI 1152 includes the metamorphic 1116 and the characters 1126-1134 used during the free spins feature game (shown in FIG. 11A). At the beginning of the star surge feature, the characters 1126-1134 and their associated characteristics may be determined as described above. Awards provided by defeating the characters 1126-1134 may be similar to those described above for characters used for the free spins feature game of FIG. 11A and/or the characters 526-534 used for the base game of FIGS. 5-10. Other additional awards may be available during this upgrade as well. For example, kraken symbols (not shown) may appear on the reel strips used for the reels 1204-1212 as described above for the reels 1104-1112. Each kraken symbol (not shown) that appears in the matrix 1154 may be evaluated as a wild and may include a multiplier value (which may range from 1×, 2×, 3×, 5×, 7×, 10×, 15×, or 20× multipliers). The multipliers may be applied to the win condition/winning symbol combination formed by the kraken symbol, or may be applied to the entire award value of the outcome appearing in the matrix 1154.

At the conclusion of the free spins game of FIG. 11A and/or the star surge feature game, any award value resulting from either feature game may be paid out (e.g., from win conditions in the matrix 1114 or 1154 and/or from prize(s) awarded by defeating one or more characters 1126-1134) and the game play instance subsequently ends at operation 432. As described above, the features of FIGS. 11A and 11B may be initiated after the award value for the base game instance is paid out at operation 430 and any prizes awarded on defeated base game characters 526-534 are paid out at operation 422. Alternatively, all prizes awarded during base game and feature game play may be paid out at operation 430 and the game instance ends at 432. If a feature game (e.g., the free spins game or star surge feature) was initiated at 434, the processor 204 controls the UI 1102 or the UI 1152 to revert back to the base game UI 502 and the base game characters 526-534 and reels 504-512 are displayed.

Before or after the game instance ends at 432, the exiting base game character 526 (which has exhausted all its spins on screen) is controlled by the UI 502 to exit the screen. This is indicated at operation 428, which may be performed at the end of the game play instance or at the beginning of the subsequent game play instance. In the example implementation, the exiting base game character 526 is controlled by the UI 502 to exit the screen at the beginning of the subsequent game play instance (initiated at operation 402) or during the spin and stop sequence of the reels 504-512 during the subsequent game play instance. In other examples, the exiting character 526 is controlled to exit the screen before the game play instance ends at operation 432. The exiting character 526 is replaced by a new transient character as described above for the next game instance at operation 406. The remaining characters 528-534 may also be controlled by the UI 502 to move vertically upward one position above the matrix 514 to visually indicate that the characters 528-534 have one fewer remaining spins on screen before exiting for subsequent game instances.

FIG. 12A shows an exemplary character lookup table 1200, similar to Table 1. The table 1200 shows the range of health values associated with a particular type and value of character. For example, the type zero 1212 XS wild character has a minimum and maximum health value of one. The type two 1214 medium wild character has a minimum health value of one, and a maximum health value of three. When a character is instantiated, the character is assigned a health value between the minimum and maximum value. The chosen health value may be chosen randomly, or may be weighted based on the prize associated with the character, with rarer or more valuable prizes being associated with higher health values.

The character lookup table 1200 may be configured to replace characters in order of type when a transient character exits play. For example, upon operation 406, the first reel 1202 is instantiated with type zero 1212, the XS wild, the second reel 1204 is instantiated with type one, the XS Wild, the third reel 1206 is instantiated with type two 1214, the medium wild, the fourth reel 1208 is instantiated with type three, a small wild, and the fifth reel 1210 is instantiated with type four, a small wild. In this example, the XS wild character on the first reel 1202 has one spin remaining before exiting the screen after operation 428. Once operation 428 is completed, the subsequent type on the lookup table replaces the exiting character. In this example, the type zero 1212 XS wild is replaced by the type 5 small wild upon completion of operation 428. In other implementations, the replacement character may be chosen randomly or based on some other criteria or algorithm.

FIG. 12B shows an exemplary characteristic lookup table 1250 containing weights for prizes. After the type of prize is selected from a first character lookup table 1200 as in FIG. 12A, a prize value is associated the type of prize, selected from the second characteristic lookup table 1250. Certain prizes may be weighted to appear more often in certain reel positions based on the prize value or may be weighted such that the prize does not appear at all in certain reel positions (e.g., to control RTP and/or provide variability). In the example lookup table, a 2×2 wild shape 1252 appears with a weight of three in the first reel 1202 and second reel 1204, a weight of one in the third reel 1206 and the fifth reel 1210, and a weight of zero in the fourth reel 1208. The 2×2 wild shape 1252 is thus more likely to be selected in the first reel 1202 and the second reel 1204, less likely to be selected in the third reel 1206 and the fifth reel 1210, and will never be selected as a prize in the fourth reel 1208.

FIG. 13 illustrates an example method 1300 for providing an electronic game on an electronic gaming device, in accordance with the present disclosure. In the example embodiment, method 1300 includes controlling 1302 a display device to display the electronic game including a set of reels and transient characters, wherein each transient character is associated with one of the reels and is displayed for a predetermined number of spins. The method 1300 also includes randomly determining 1304 a prize and a number of health points for each transient character. The method 1300 also includes controlling 1306 the display device to spin and stop the set of reels and display a set of symbols on each stopped reel. The method 1300 also includes determining 1308, for each stopped reel, whether the set of symbols includes an attack symbol that causes the number of health points of the transient character associated with the reel to reach zero. The method 1300 also includes, when the number of health points for any of the transient characters reaches zero, generating 1310 an award that includes the prize for the transient character having zero health points. The method 1300 also includes controlling 1312 the display device to remove each transient character having zero remaining spins, determined after the reels are stopped. The method 1300 also includes, for each removed transient character, controlling 1314 the display device to display a new transient character and determining a prize and a number of health points for the new transient character.

In some embodiments, the method 1300 includes performing a first lookup in a first lookup table to select a type of character, and based on the selected type of character, determining a second lookup table from a plurality of second lookup tables each associated with different types of characters. The method 1300 also includes performing a second lookup in the determined second lookup table to determine the prize and number of health points.

In some embodiments, the method 1300 includes restoring each transient character having zero remaining health points after the respective award is generated.

In some embodiments, the method 1300 includes, when the number of health points for a transient character having a free spins prize reaches zero, initiating a free spins feature game on the display device, wherein the free spins feature game includes display of feature characters each associated with one feature reel of a set of feature reels, wherein each feature character has a prize and a number of health points determined when the free spins feature game is initiated.

In some embodiments, the method 1300 includes dynamically determining a number of damage points caused by each attack symbol appearing on each reel to the transient character associated with the reel.

In some embodiments, the method 1300 includes controlling the display device to visually indicate that each transient character having at least one remaining spin, determined after the reels are stopped, has one fewer remaining spin than before the reels are spun and stopped.

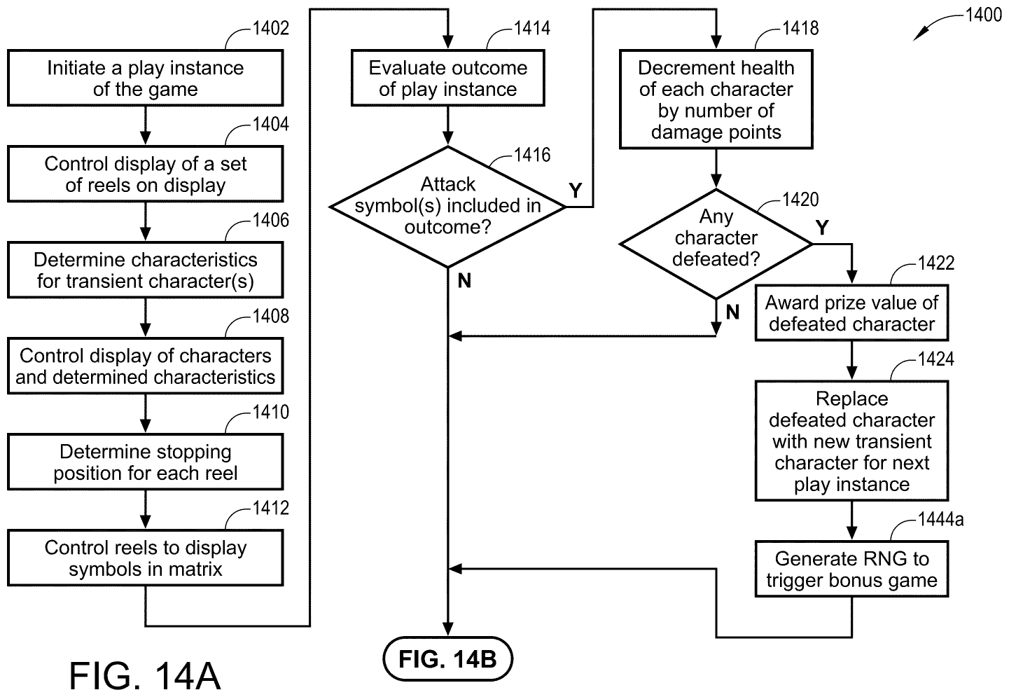

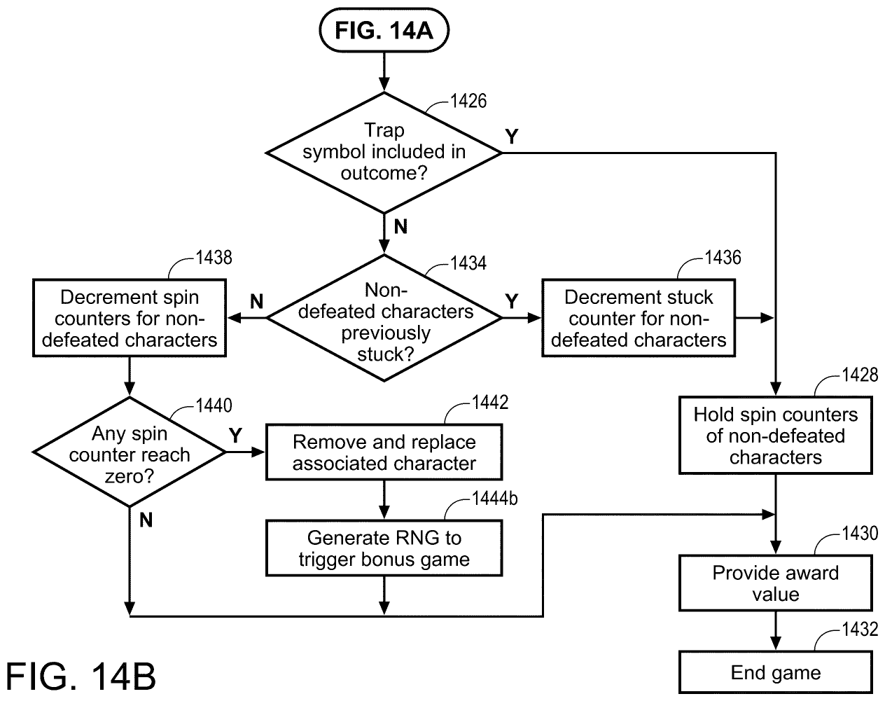

FIG. 14A and FIG. 14B are a flow chart of an exemplary process 1400 for executing electronic game play for display to a user. The process 1400 may be implemented in a server (e.g., server 106) and/or a gaming device (e.g., gaming devices 104A-104X in FIG. 1, and/or gaming device 200 and/or mobile gaming device 256 and/or EUDs 264a-c in FIG. 2). For example, in an electronic gaming device, a game controller (e.g., game controller 202) includes one or more processors 204 operatively coupled to memory 208. The memory 208 can store one or more game programs 206 that provide program instructions and/or data for carrying out various implementations (e.g., game mechanics) that, when executed by the processor 204, cause the processor 204 to perform certain operations to perform the process 1400. Description of the operations of the process 1400 being performed by the processor 204 includes implementations where multiple processors 204 are utilized. Moreover, some of the operations of the process 1400 may be performed at the gaming device while some of the operations of the process may be performed at the server 106. The numerical ordering/sequencing of the process 1400 shown in FIGS. 14A and 14B and described herein is not intended to limit the process to any particular order of the operations described herein. More broadly, the order of the actions described herein for the process 1400 are not limited to any particular order unless expressly stated otherwise or the context clearly indicates otherwise.

At operation 1402, the processor 204 initiates a play instance of a game. The play instance may be initiated at operation 1402 in response to a player input indicative of a desire to play the game. In some embodiments, prior to initiating the play instance, the processor 204 first receives a selection of a bet option from the player, for example, via buttons 236. In an example, there are a plurality of bet options where bet1<bet2<bet3 etc.

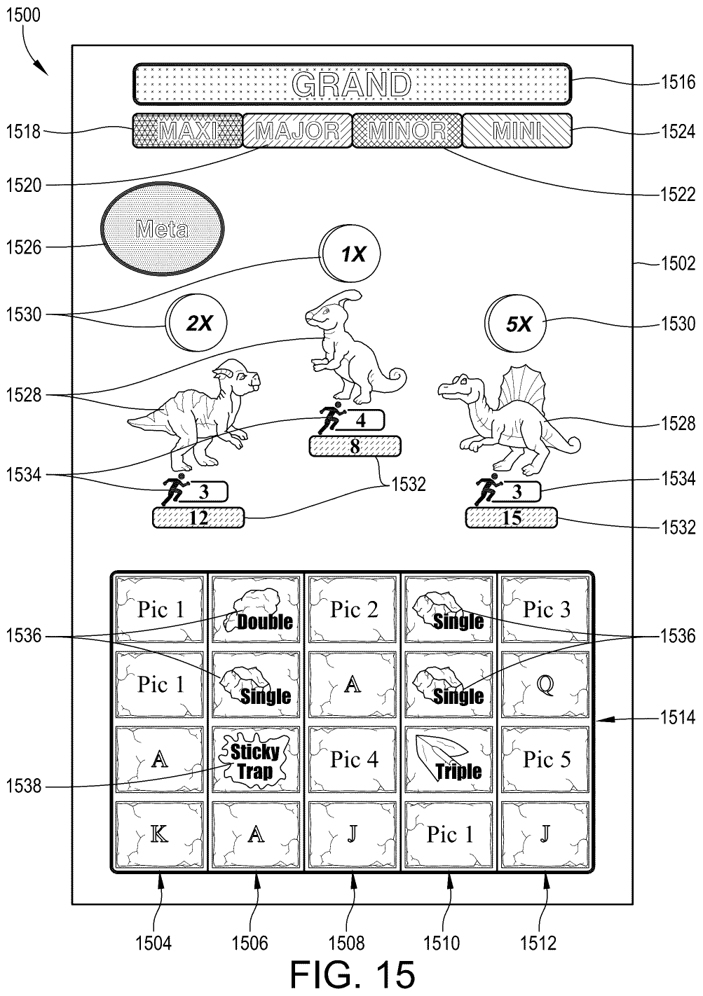

At operation 1404, the processor 204 controls a display, such as display 240, to display a plurality of reels in a viewable matrix of symbol positions for the game instance initiated at operation 1402. FIG. 15 shows a screen capture 1500 of the game play presented on a user interface (UI) 1502 (e.g., a UI of the UI system 302, such as game play UI 304). In the illustrated example, there are five reels 1504-1512 respectively displayed in one of five columns of a matrix 1514 of symbol positions. Each reel 1504-512 includes a number of rows viewable in a corresponding number of symbol positions of the matrix 1514. The matrix 1514 is a 4×5 matrix in the illustrated example, such that each of the five reels 1504-1512 includes four rows viewable in four symbol positions of the matrix 1514, which includes 20 total symbol positions. In other implementations, the matrix 1514 may have other configurations and different numbers of symbol positions (e.g., different numbers of columns and respective rows) than shown in the example implementation of FIG. 15. As such, there may be more or fewer than five reels 1504-1512. Additionally and/or alternatively, each reel 1504-512 may include more or fewer than four rows displayed in four symbol positions.

In the example implementation, the game UI 1502 is presented on a display, such as display 240 of a mobile or remote device 256 (FIG. 2B), such as a smart phone, tablet, computer, or any other suitable remote device. One or more of the steps of the process 1400 may be performed by one or more processors, such as a processor of the remote device and a processor of a central server (e.g., server 106) in communication with the remote device. In other implementations, the game UI 1502 is presented on a display of a gaming device located on a casino floor (e.g., gaming devices 104A-104X in FIG. 1, and/or gaming device 200 in FIG. 2A). In some such embodiments, one or more of the steps of the process 1400 may be performed locally at the gaming device (e.g., via a game control 202) and/or by a central server (e.g., server 106).

The UI 1502 may also display additional graphics associated with the electronic game. For example, the UI 1502 may include, in addition to the matrix 1514, jackpot meters 1516-1524, including a grand jackpot meter 1516, a maxi jackpot meter 1518, a major jackpot meter 1520, a minor jackpot meter 1522 and a mini jackpot meter 1524. In some examples, there may be different jackpot meters and/or more or fewer than the five jackpot meters provided by the UI 1502. The UI 1502 may, in some implementations, also provide one or more metamorphical graphical elements 1526, or metamorphic(s) 1526, that transform (e.g., by animation provided on the UI 1502) to visually indicate various features of the electronic game that may be triggered during base game play. Any types of metamorphics, objects, symbols, or other graphic elements may be used and provided on the UI 1502 to visually inform progress of the electronic game or features of game play. The UI 1502 may also provide a credit meter indicating a credit balance of a player of the electronic game, a bet meter, and one or more input buttons (e.g., a SPIN button) that may be selected to initiate a play of the electronic game or provide some other game play input. The elements provided by the UI 1502 are by way of example only, and may be displayed on alternative displays such as those described elsewhere herein. The UI 1502 may also provide additional graphics other than those illustrated and described.

In the example implementation, one or more transient characters 1528 are provided by the UI 1502. The characters 1528 are monsters or dinosaurs in the illustrated example. Other types of characters may be used in other examples. As shown in FIG. 15, the characters 1528 are displayed adjacent (e.g., above) the matrix 1514 in the illustrated example. The characters 1528 may be displayed in any suitable location, and in some examples may be displayed on a secondary display separate from the matrix 1514. Each character 1528 includes three characteristics: a prize or award value (indicated by a prize identifier 1530), a health or number of points that needs to be reduced to zero by “attacks” on the character to win the associated prize (indicated by a health meter 1532), and a number of spins (or game instances) during which the character will remain on the screen (indicated by a spin counter 1534). The characters 1528 are “transient” in that they remain displayed for a limited number of spins, indicated by the associated spin counter 1534. After each spin (or each game instance), the associated spin counter 1534 for each character 1528 is decremented by one spin. Once the spin counter 1534 reaches zero, the character 1528 exits the display. In the example implementation, the prize associated with each character 1528, as indicated by the prize identifiers 1530, is a multiplier value. The multiplier value may be applied to the award value of the outcome of the game play instance or to the bet level of the player to initiate the game play instance at operation 1402, and a credit value is paid out on that multiplied value. Other prizes may be included for the characters 1528 in other examples (e.g., a credit value, a jackpot, free spins, etc.).

As indicated by the prize identifiers 1530 in FIG. 15, the characters 1528 may have different award values (e.g., different multiplier values in the example implementation). Characters 1528 with relatively higher prize values (e.g., greater multiplier value) may also have a greater health (e.g., require a greater number of attacks to be awarded the prize) and/or a smaller number of spins (e.g., the player has fewer chances to attack the character). Characters 1528 with relatively lower prize values (e.g., lower multiplier value) may also have a lower health (e.g., require a smaller number of attacks to be awarded the prize) and/or a greater number of spins (e.g., the player has more chances to attack the character). In the illustrated example, three characters 1528 are provided by the UI 1502. In other implementations, more or fewer characters 1528 may be provided.

Referring again to FIG. 14A and FIG. 14B, at operation 1406, the processor 204 determines the characteristics for each character 1528 provided by the UI 1502 at the initiation of the game play instance. To make this determination, the processor 204 may perform one or more lookup operations or “lookups” for each character 1528 in one or more lookup tables stored in memory (e.g., the memory 208) to determine the characteristics of that character. Each lookup may be performed by mapping a random number provided by a random number generator (RNG) (e.g., the RNG 212 of FIG. 2A) to one of a plurality of entries in a lookup table and selecting the mapped entry. The result of the lookup may also be referred to as a generated RNG outcome.

In the example implementation, the processor 204 performs two lookups for each of the three characters 1528 at operation 1406. The first lookup determines the type of character 1528, which may be a high value character type, a medium value character type, or a low value character type. The first lookup may be referred to as a character type lookup. To perform the character type lookup for each character 1528, the processor 204 may map a random number provided by the RNG 212 to a character type lookup table that includes an entry for each of the high value character type, the medium value character type, and the low value character type. The character type entries may have different weights corresponding to different probabilities of being selected based on the lookup. For example, the low value character type may have the greatest weight (or greatest probability) of being selected, and the high value character type may have the lowest weight (or lowest probability) of being selected. In one implementation, the low value character type entry may have a weight corresponding to a 50% chance of being selected, the medium value character type entry may have a weight corresponding to a 35% chance of being selected, and the high value character type entry may have a weight corresponding to a 15% chance of being selected. Table 2 below shows an example character type lookup table that may be used in such an implementation:

TABLE 2
Character Type Lookup Table

| Character Type | Weight | Probability |
|---|---|---|
| Low Value | 50 | 50.00% |
| Medium Value | 35 | 35.00% |
| High Value | 15 | 15.00% |

When the character type of a respective character 1528 is determined based on the character type lookup, the processor 204 then determines the characteristics of the character using a second lookup, also referred to as a characteristic lookup. In the example implementation, the characteristic lookup is performed by mapping a random number provided by the RNG 212 to a characteristic lookup table that includes entries for the prize value, health, and number of spins for the character 1528. This may be the same or a different random number used for the character type lookup. Because each entry includes the prize value, health, and number of spins for the character 1528, one characteristic lookup is performed for each character 1528. In other implementations, a separate characteristic lookup may be performed for each characteristic (e.g., separate lookups may be performed for each of the prize value, the health, and the number of spins for the character 1528). An example character type lookup table is shown in FIG. 12A. The character type lookup table 1200 provides both the character type (for example, XS and small might correspond to a low value in table 2) and a range of possible health values.

In the example implementation, the characteristic lookup table used for the characteristic lookup depends on the character type selected in the character type lookup. For example, the memory 208 may store different characteristic tables for the low value character type, the medium value character type, and the high value character type. The characteristic entries differ depending on the character type. For example, the characteristic entries of the lookup table for the low value character type may have generally smaller prize values, and the characteristic entries of the lookup table for the high value character type may have generally larger prize values. As described above, the health and number of spins also vary depending on the prize value, and this may be reflected in the characteristic lookup tables of the different character types. Example characteristic lookup tables for the different character types are shown below in Tables 3-5, as well as in FIG. 12B.

TABLE 3
Characteristic Lookup Table for Low Value Character Type

| Health | Spins | Prize | Weight | Probability |
|---|---|---|---|---|
| 10 | 3 | 1 | 20 | 25.00% |
| 10 | 2 | 1 | 18 | 22.50% |
| 12 | 3 | 1.5 | 15 | 18.75% |
| 14 | 3 | 2 | 12 | 15.00% |
| 16 | 4 | 2 | 10 | 12.50% |
| 18 | 4 | 3 | 5 | 6.25% |

TABLE 4
Characteristic Lookup Table for Medium Value Character Type

| Health | Spins | Prize | Weight | Probability |
|---|---|---|---|---|
| 20 | 4 | 3 | 20 | 25.00% |
| 20 | 3 | 5 | 18 | 22.50% |
| 22 | 5 | 3 | 15 | 18.75% |
| 22 | 4 | 4 | 12 | 15.00% |
| 24 | 5 | 3 | 10 | 12.50% |
| 25 | 4 | 5 | 5 | 6.25% |

TABLE 5
Characteristic Lookup Table for High Value Character Type

| Health | Spins | Prize | Weight | Probability |
|---|---|---|---|---|
| 26 | 6 | 4 | 20 | 25.00% |
| 28 | 7 | 5 | 18 | 22.50% |
| 28 | 6 | 6 | 15 | 18.75% |
| 30 | 6 | 7 | 12 | 15.00% |
| 32 | 7 | 8 | 10 | 12.50% |
| 35 | 7 | 10 | 5 | 6.25% |

As shown in Tables 3-5, the entries in each characteristic table vary the prize value, health, and number of spins that may be selected by the characteristic lookup. The example table shown in FIG. 12B varies the prize value, as health may be decided based on the character type lookup table 1200 and spins may either be set to a predetermined value or determined based on a separate lookup table. For example, the entries of each characteristic table may have varying prize values. In each characteristic table, the entries having the relatively larger prize values may have a lower weight (lower probability of being selected) and the entries having the relatively lower prize values may have a greater weight (greater probability of being selected). The Tables 2-5 provided above and FIG. 12B are by way of example only. The entries and relative probability may vary depending on the implementation of the game. Further, more or fewer lookup tables may be used for the determination of the character type and/or characteristics of each character 1528. For example, the character type lookup may select from more than three character types, and the number of characteristic lookup tables may vary depending on the number of possible character types.

At operation 1408, the processor 204 controls the UI 1502 to display the characters 1528 and their respective characteristics determined at operation 1406. The characteristics are populated in the prize identifier 1530, health meter 1532, and spin counter 1534 for each character 1528. As shown in FIG. 15, the characteristics determined at the initiation of the example game instance are as follows: one of the characters 1528 has a 5× multiplier, a health of 16 points, and is on screen for 3 spins; another one of the characters 1528 has a 2× multiplier, a health of 12 points, and is on screen for 3 spins; and another one of the characters 1528 has a 1× multiplier, a health of 8 points, and is on screen for 4 spins. The character type of each character (e.g., high value, medium value, or low value) may be indicated by the monster/dinosaur used for the character 1528, and this may also be determined at operation 1406. Alternatively, the monster/dinosaur used as the character 1528 may be independent of the character type selected for the character 1528, such that the same monster/dinosaur character could have high value, medium value, or low value characteristics depending on the determination at operation 1406. In some examples, the monster/dinosaur used as each character 1528 may be determined by another lookup. In some examples, the monster/dinosaurs used as the characters 1528 may be used at predefined (regular or irregular) intervals.

As described above, the characters 1528 remain on the UI 1502 for at least the number of spins indicated in the respective spin counter 1534. At the beginning of some game play instances initiated at operation 1402, each of the three characters 1528 may have remained on the UI 1502 from a previous game play instance because all the spin counters 1534 remain above zero. For such game play instances, the processor 204 may not perform operations 1406 and 1408.

At operation 1410, the processor 204 determines a stopping position for each of the reels 1504-1512 (FIG. 15) for display of a combination of symbols in the matrix 1514. During the game play instance initiated at 1402, symbols may be selected (e.g., such as from the reel strips associated with the reels 1504-1512) and displayed in the symbol positions within the matrix 1514. Each reel strip associated with one of the reels 1504-1512 may include a plurality of symbols arranged in a vertical column. In the example embodiment, the reel game uses virtual reel strips for the reels 1504-1512. The reel strips may include various basic symbols (e.g., “A”, “K”, “Q”, “J”, “10”, “9”, picture symbols), as well as feature symbols. The feature symbols may, in some examples, include bonus game symbols and/or cash on reel (COR) symbols. The bonus game symbols may trigger a bonus game when a triggering number appears in the matrix 1514. The COR symbols correspond to credit values that may be awarded for each COR symbol appearing in the matrix 1514. A number of symbols of each reel, corresponding to the number of rows of the matrix 1514, is displayed in a column of symbol positions within the matrix during game play. In some implementations, a separate reel, e.g., an independent reel, may be utilized for each symbol position of the matrix 1514.

In the example implementation, the feature symbols included on the reel strips for at least some of the reels 1504-1512 include attack symbols 1536 and trap symbols 1538 that, when displayed on the reels 1504-1512 in the matrix 1514, operate against the characters 1528. Attack symbols 1536 and trap symbols 1538 are shown in the screen capture 1500 of FIG. 15. In the example implementation, each attack symbol 1536 and each trap symbol 1538 that appears in the matrix 1514 operates against each character 1528. In other implementations, certain attack symbols 1536 and/or certain trap symbols 1538 may operate only against certain characters 1528. For example, the characters 1528 may be associated with one or more of the reels 1504-1512 and only attack symbols 1536 and/or trap symbols 1538 appearing on the associated reels operate against that character.

The attack symbols 1536 appearing in the matrix 1514 decrement the health meter 1532 of each character 1528 by a certain amount of points. The number of health points decremented by the attack symbols 1536, or the damage that the attack symbols 1536 cause, may vary between different types of attack symbols. In the example implementation, the reel strips include three types of attack symbols 1536—single attack symbols (corresponding to one health point of damage to each character 1528), double attack symbols (corresponding to two health points of damage to each character 1528), and triple attack symbols (corresponding to three health points of damage to each character 1528). In other implementations, any suitable number of different types of attack symbols 1536 may be used. The different types of attack symbols 1536 may be indicated by graphical elements (e.g., identifiers or words on the symbol) and/or by different types of symbols (e.g., different pictures) used for the different attack symbols. As shown in FIG. 15, the single, double, and triple attack symbols 1536 that are included on the reel strips are differentiated by different picture symbols and by words that identify the attack symbol type.

The trap symbols 1538 “stick” each of the characters 1528 in place, thereby stopping the spin counter 1534 of each character 1528 at the end of one or more spins/game instances. In the example implementation, each trap symbol 1538 is applied to each character 1528 for three spins, meaning that the spin counters 1534 do not decrement at the end of the next three spins/game instances. If a trap symbol 1538 lands and the characters 1528 have previously been “stuck” by another trap symbol, the “sticky count” is reset to three. In other implementations, the number of spins/game instances that the characters 1528 remain stuck by the trap symbols 1538 may vary. Defeating a stuck character 1528 by reducing the health meter 1532 to zero when a trap symbol 1538 is applied may increase the prize value (e.g., increase the multiplier value) awarded.

Based on the stopping positions for the reels 1504-1512 determined at operation 1410, the UI 1502 causes display of a number of symbols of each reel, corresponding to the number of rows in the respective column, within the reel matrix 1514 during the game play instance. To display symbols from a reel within the matrix 1514, the processor 204 may control, at operation 1412, the UI 1502 to simulate rotation or spinning of one or more of the reels 1504-1512 within a respective column. When a respective reel is simulated to halt or stop within an associated column, one or more symbols may be displayed from the reel strip in the symbol positions of the column. Alternatively, in implementations in which independent reels are used, each reel may be controlled to independently spin and stop and display a symbol in its respective symbol position in the matrix 1514. The symbols displayed after spinning and stopping each reel in a respective column or symbol position of the reel matrix 1514 may be referred to herein as a “reel outcome” or a “base reel game outcome” or a “base game outcome.” More broadly, an “outcome” of a reel game refers to the symbols displayed in a reel matrix after reels are spun and stopped. Thus, a rotation and stopping of the reels 1504-1512 (also referred to herein as a “spin and stop sequence”) may be simulated by the UI 1502 within the columns of the matrix 1514 to cause a reel outcome, including a plurality of symbols, to be displayed from the associated reel strips within the matrix. Each play of the reel game may include one or more reel game outcomes, that is, each play of the reel game may include a single spin and stop sequence of the reels 1504-1512 or multiple spin and stop sequences.

Following operation 1412, symbols are displayed on each of the reels 1504-1512 within the matrix 1514, forming an outcome of a game instance that may then be evaluated. Accordingly, at operation 1414, the processor 204 evaluates the outcome (e.g., the symbols displayed within the matrix 1514) for winning symbols and/or symbol combinations that provide an award or another game feature to the player. Any win conditions within the matrix 1514 can be detected by the processor 204 and any win amounts can be awarded to the player (e.g., credited to the player's credit balance). The win conditions may be defined according to a “ways” approach or may be defined as pay lines or win lines. In the example implementation, the win conditions are defined according to a ways approach, in which symbols displayed at symbol display positions within one of the columns of the matrix 1514 can be used to form symbol combinations (one symbol per reel in a combination) with the symbols displayed at designated symbol display positions of each of the other columns of the matrix 1514. For example, in the example matrix 1514 in which there are five reels 1504-1512, and four symbol display positions for each reel 1504 and 506 and four symbol display positions for each reel 1508-1512, each possible path through the symbol display position(s) of the respective reels may provide a way to win. The total number of ways to win in the matrix 1514 may be determined by multiplying the number of active display position(s) of each reel 1504-512, where the active display position(s) for a reel are all display positions in the matrix 1514. As a result, there 4×4×4×4×4=1024 ways to win for the matrix 1514. In other implementations, win conditions may be defined as pay lines (also called win lines) across at least a portion of the reel matrix 1514. In these other implementations, when a certain combination of symbols appears along a pay line, a win amount corresponding to that combination of symbols and that pay line may be awarded. Win amounts can vary according to the combination of symbols and according to the particular pay line along which the combination of symbols appears. Win amounts are typically determined according to a pay table, where the pay table comprehends the various combinations of symbols and pay lines that may occur (e.g., the win conditions). The win amount for a round of play may be a fraction of an amount wagered for that round of play for certain win conditions. For other win conditions, the win amount may be much larger than the amount wagered.

The evaluation at operation 1414 includes determining whether any feature symbols are displayed on the reels 1504-1512 that may provide certain awards and/or unlock certain features of the game once all the reels 1504-1512 have spun and stopped. For example, the processor 204 may determine whether any symbols that are treated as “wild” symbols for the purposes of evaluating the outcome at operation 1414 are displayed in the matrix 1514. The processor 204 may additionally and/or alternatively determine whether any bonus game symbols and/or COR symbols are displayed in the matrix 1514. On the basis of this evaluation, the processor 204 may determine the award value associated with the combination of symbols displayed within the matrix 1514 and/or whether a bonus game is triggered.

For the purposes of evaluating the symbols within the matrix 1514 at operation 1414, the attack symbols 1536 (and the trap symbols 1538), if any, that appear on the reels 1504-1512 may be treated as “blocking” symbols. That is, any symbol position within the matrix 1514 that includes an attack symbol 1536 or a trap symbol 1538 may be blocked or precluded from forming a winning symbol combination. For example, in the outcome shown in the screen capture 1500 of FIG. 15, the top three rows (top three symbol positions) of the second reel 1506 and the fourth reel 1510 that include either an attack symbol 1536 or a trap symbol 1538 are precluded from forming a way to win (under a ways approach) or a winning pay line.

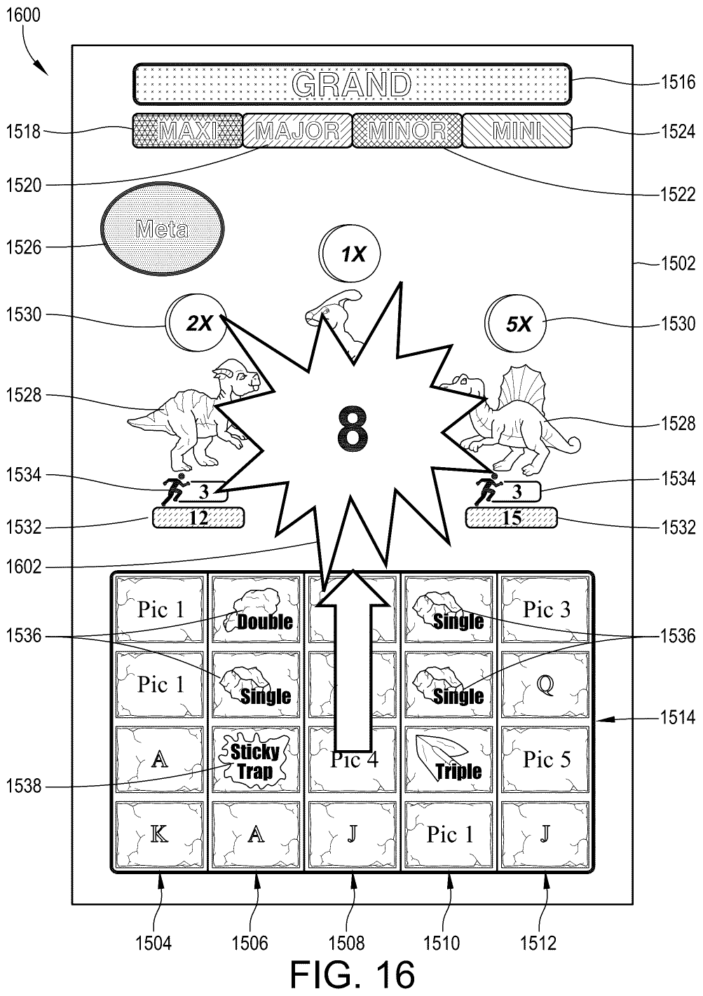

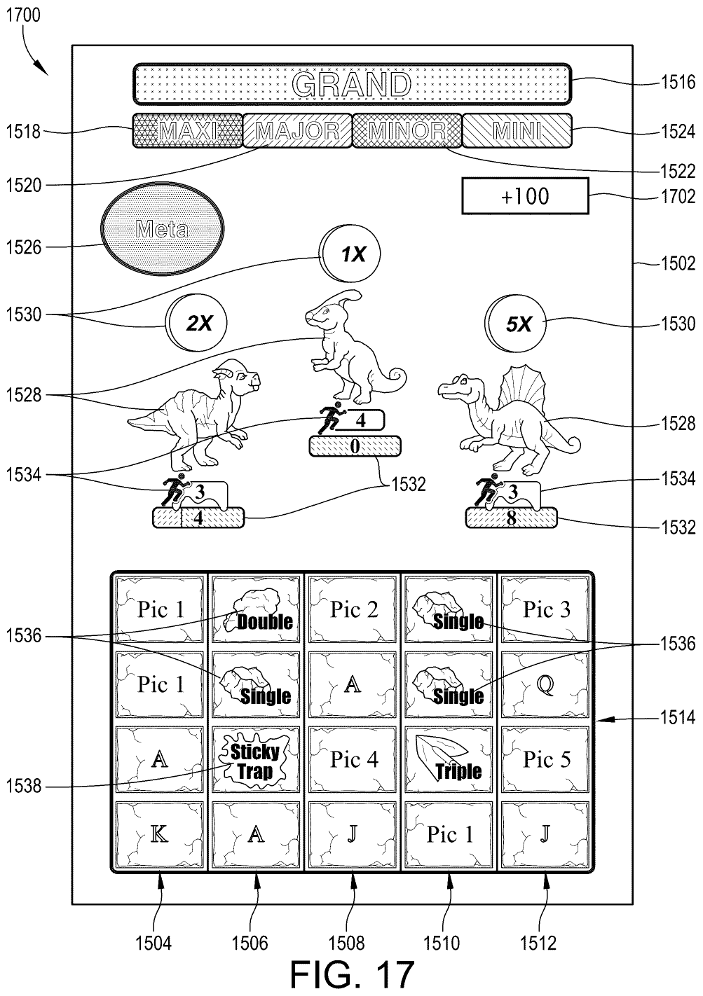

Based on the evaluation at operation 1414, the processor 204 determines at operation 1416 whether any attack symbols 1536 are displayed within the matrix 1514 on the reels 1504-1512. When one or more attack symbols 1536 are displayed, the processor 204 controls, at operation 1418, the UI 1502 to decrement the health meter 1532 of each character 1528 by the number of health points corresponding to the number of damage points associated with the attack symbols 1536 in the matrix 1514. In the outcome shown in FIG. 15, the attack symbols 1536 that appear have a combined 8 damage points, and the processor 204 at operation 1418 decrements the health meter 1532 of each character 1528 by 8 health points. The processor 204 may also control the UI 1502 to provide an animation effect 1602 (shown in FIG. 16) to visually inform the player that the attack symbols 1536 operate against the characters 1528 and result in the decremented health meters 1532. In the illustrated example, shown in the screen shot 1600 of FIG. 16, the animation effect 1602 indicates an 8-point hit against the characters 1528. FIG. 17 is a screen shot 1700 showing the health meters 1532 of the characters 1528 decremented by 8 health points following the outcome of FIG. 15. As described above, while all attack symbols 1536 operate against each character 1528 in the example implementation, in some other implementations, certain attack symbols 1536 may operate against certain characters 1528. That is, in some such implementations, the combined total damage points may not operate against the health meter 1532 of each character 1528, and the damage points of the attack symbols 1536 may apply to only certain characters 1528.

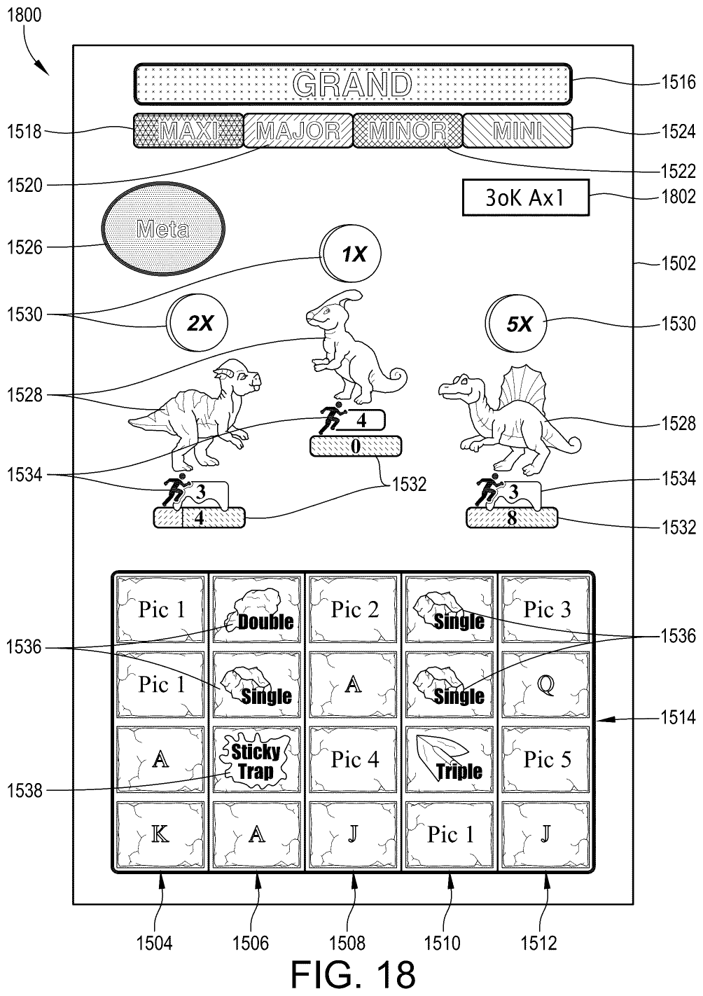

At operation 1420, when one or more attack symbols 1536 appear and operate against the health meters 1532 of the characters 1528, the processor 204 determines whether any of the characters 1528 are “defeated,” that is, whether the health meter 1532 of any character is reduced to zero based on the “hit.” If no characters 1528 are defeated, then none of the prize values are awarded. If one or more of the characters 1528 are defeated, processor 204 at operation 1422 determines and awards the prize value (indicated by the prize identifier 1530) associated with the defeated character to the player. This prize value may be paid out at the conclusion of the game play instance (operation 1430). In the illustrated example, as shown in FIG. 17, the character 1528 having the 1× multiplier is defeated. As described above, the multiplier value of the defeated character may be applied to the bet level to initiate the play instance at 1402 and paid out as a credit value, and/or may be applied to the award value of the outcome evaluated at operation 1414. A visual indication may be displayed to visually inform the award paid out for defeating the character 1528. FIG. 17 shows an indication 1702 that a 100 credit award is paid out (by multiplying the 1× multiplier of the defeated character 1528 to the bet level). FIG. 18 shows a screen shot 1800 with a visual indication 1802 of the award value of the outcome evaluated at operation 1414 and the 1× multiplier of the defeated character 1528 applied to that award value. These may be awarded separately or in combination.

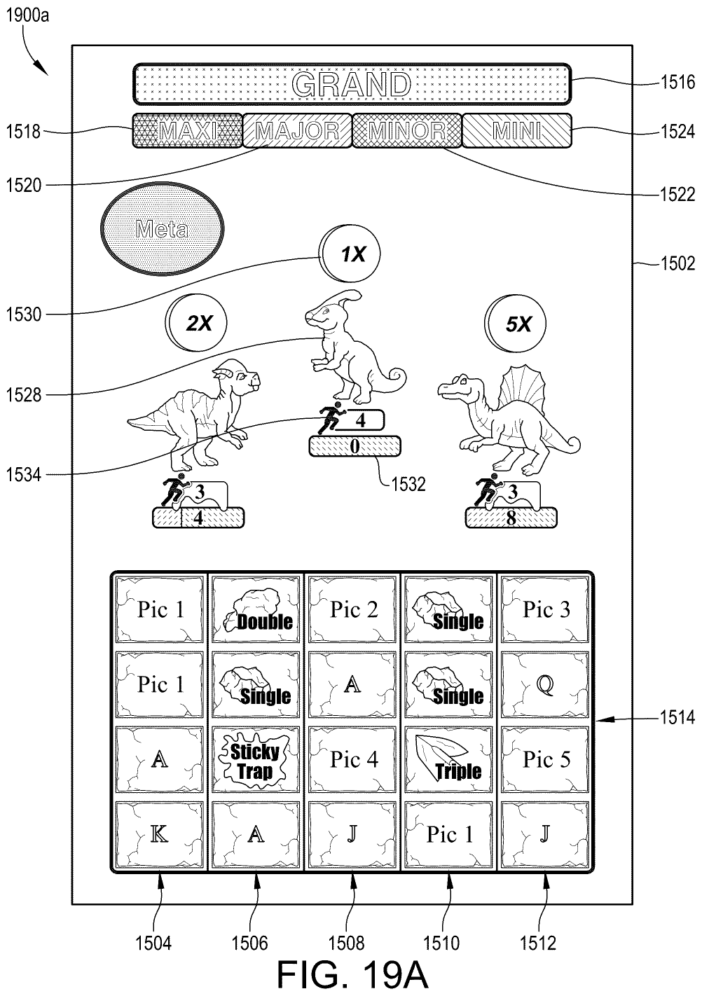

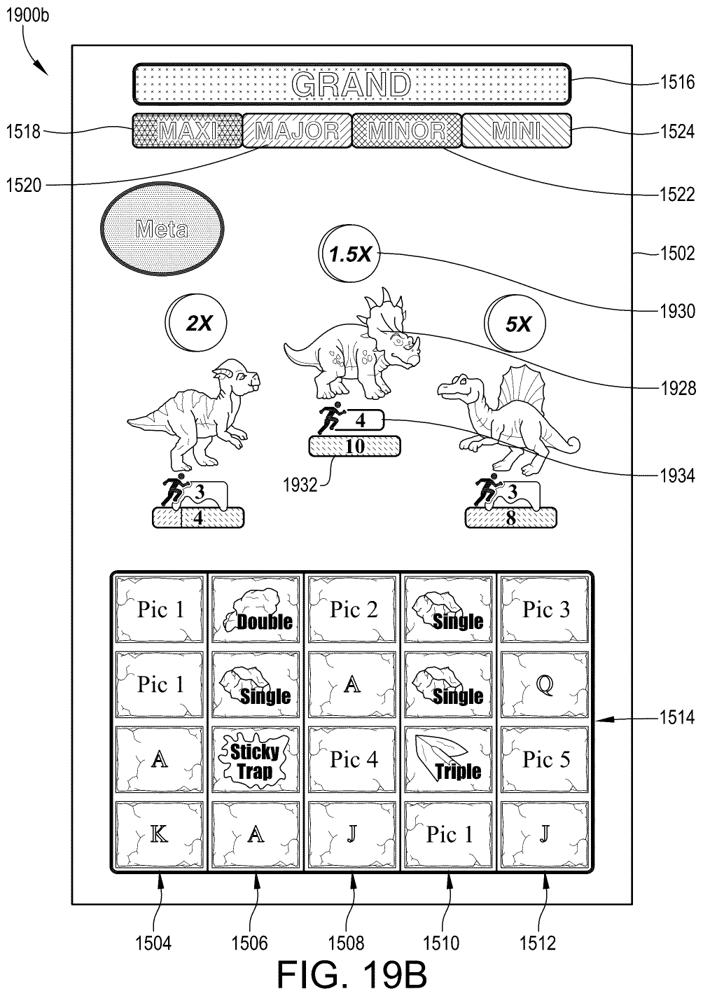

At operation 1424, the processor 204 controls the UI 1502 to replace the defeated character 1528 with another transient character 1528 for the next play instance (next spin) of the game. This is illustrated by the sequence shown in the screen captures 1900a and 1900b of FIGS. 19A and 19B, respectively, in which the defeated 1× character 1528 (FIG. 19A) is replaced by a new transient character 1928 (FIG. 19B) having a prize (multiplier) value of 1.5× (indicated by the prize identifier 1930), health of 10 points (indicated by the health meter 1932), and is on screen for 4 spins (indicated by the spin counter 1934). The character type (award value type) and characteristics of the new character shown in FIG. 19B may be determined as described above for the operations 1406 and 1408. For example, when one or more of the characters 1528 are defeated, the processor 204 may determine the type and characteristics for each new/replacement character 928 provided by the UI 1502 by performing a character type lookup in the character type lookup table (e.g., Table 2, FIG. 12A) and a characteristics lookup using the characteristics lookup table associated with the selected character type (e.g., one of Tables 3-5, FIG. 12B).

At operation 1426, which may be performed before, after, or concurrently with the determination at operation 1416 or the subsequent operations 1418-1424 described above, the processor 204 determines whether a trap symbol 1538 is displayed within the matrix 1514 on the reels 1504-1512. When a trap symbol 1538 is displayed, the processor 204 controls, at operation 1428, the UI 1502 to display an indication that each (non-defeated) character 1528 is “stuck” and to hold the spin counters 1534 of the non-defeated character 1528 (e.g., refrain from decrementing the spin counters 1534 of the non-defeated characters 1528). Referring to FIG. 18, in response to the trap symbol 1538 appearing in the FIG. 15 outcome, the two characters 1528 that were not defeated by the attack symbols 1536 are indicated as “stuck” by a graphical effect adjacent the spin counters 1534, which are not decremented. The UI 1502 may also provide a “stuck counter” to visually indicate the number of subsequent game instances/spins over which the characters 1528 will remain stuck (e.g., will not have their respective spin counters 1534 decremented). As shown in FIGS. 19A and 19B, the trap symbol 1538 is only applied to the non-defeated characters 1528, and is not applied to the new character 1928 (FIG. 19B) that replaces the defeated character 1528. Accordingly, for a next/subsequent spin, the spin counters 1534 of the stuck characters 1528 are not decremented, while the spin counter 1934 of the new character 1928 may be decremented (unless another trap symbol 1538 appears). Furthermore, if, during a previous spin, the non-defeated characters 1528 were stuck by a trap symbol 1538, and remained stuck when the trap symbol 1538 appeared in the FIG. 15 outcome, the number of spins remaining over which the non-defeated characters 1528 are stuck is reset at operation 1428. The award value of the evaluated outcome at operation 1414 and prize value, if any, awarded on a defeated character 1528 may be provided at operation 1430 and the game instance ends at operation 1432.

When the processor 204 determines, at operation 1426, that there are no trap symbols 1538 in the outcome of the game play instance, the processor 204 at operation 1434 determines whether the non-defeated characters 1528 were previously stuck by a trap symbol 1538. If the non-defeated characters 1528 were previously stuck, the processor 204 decrements a stuck counter (not shown) by one spin at operation 1436, which may result in the non-defeated characters 1528 becoming unstuck for a subsequent game instance, but does not decrement the spin counters 1534 of the non-defeated characters 1528. If the non-defeated characters 1528 are not stuck, the processor 204 decrements the spin counters 1534 of the non-defeated characters 1528 at operation 1438 and determines, at operation 1440, whether this results in any of the spin counters 1534 reaching zero remaining spins. If not, the award value is paid out at 1430 and the game ends at 1432.

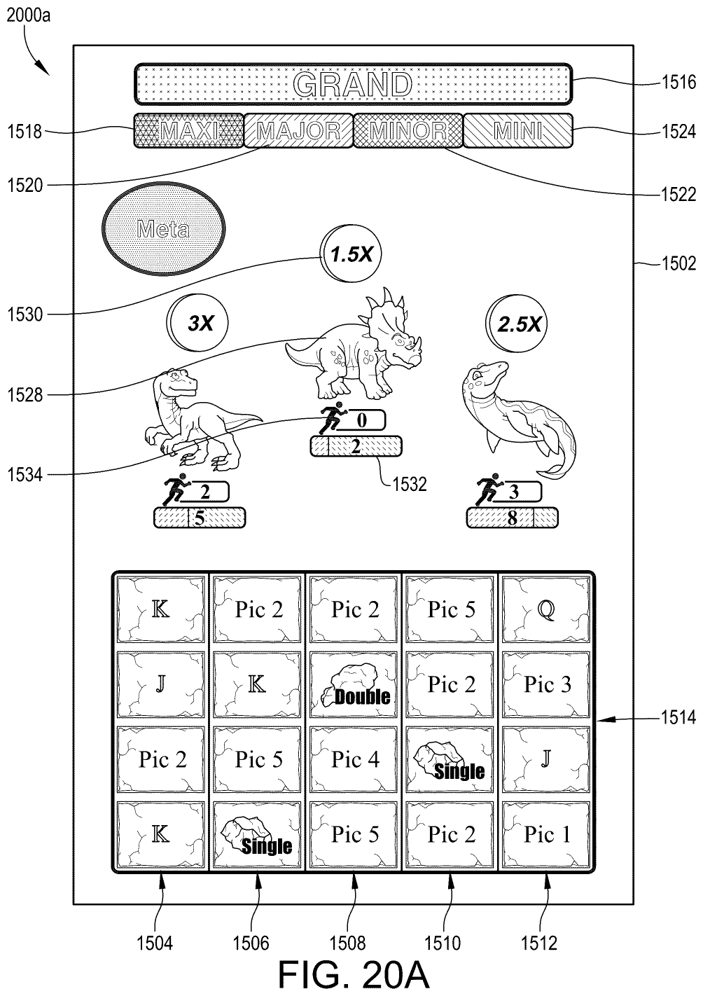

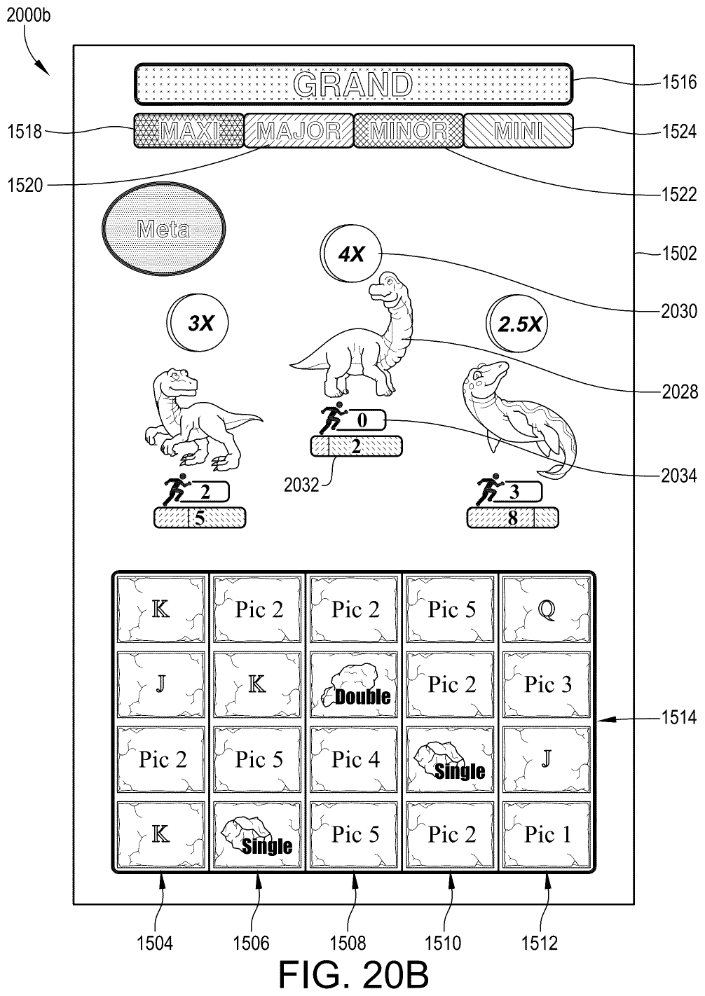

If any of the non-defeated characters 1528 reach zero remaining spins in the spin counter 1534 decremented at 1438, the processor 204 at operation 1442 controls the UI 1502 to remove and replace that character 1528 with another transient character 1528 for the next play instance (next spin) of the game. This is illustrated by the sequence shown in the screen captures 2000a and 2000b of FIGS. 20A and 20B, respectively, in which one of the characters 1528 has a spin counter 1534 that reaches zero remaining spins (FIG. 20A) and is replaced by a new transient character 2028 (FIG. 20B) having a prize (multiplier) value of 4× (indicated by the prize identifier 2030), health of 20 points (indicated by the health meter 2032), and is on screen for 5 spins (indicated by the spin counter 2034). The character type (award value type) and characteristics of the new character shown in FIG. 20B may be determined as described above for the operations 1406 and 1408. For example, when one or more of the characters 1528 has a spin counter 1534 that reaches zero at operation 1438, the processor 204 may determine the type and characteristics for each new/replacement character 1028 provided by the UI 1502 by performing a character type lookup in the character type lookup table (e.g., Table 2, FIG. 12A) and a characteristics lookup using the characteristics lookup table associated with the selected character type (e.g., one of Tables 3-5, FIG. 12B).

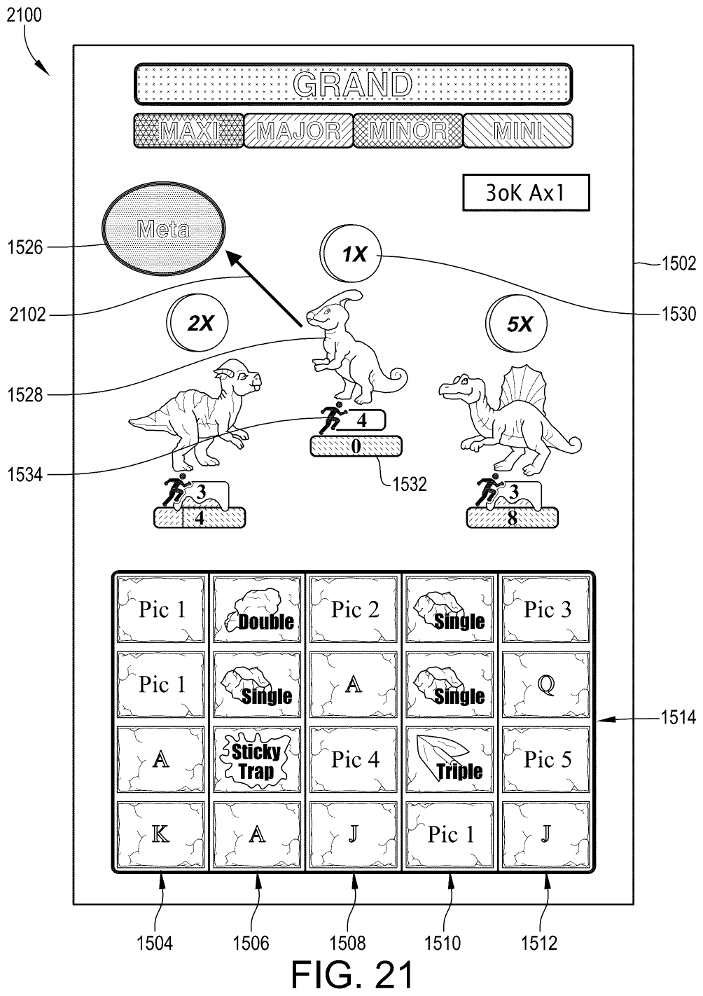

Referring to FIG. 21, when one or more characters 1528 are defeated at operation 1418 or one or more non-defeated characters 1528 reach zero remaining spins at operation 1438, the processor 204 may also control the UI 1502 to display an animation effect 2102 showing the character exiting the display. In the illustrated example shown in FIG. 21, the UI 1502 displays the animation effect 2102 which includes the defeated character 1528 running off the screen and into the metamorphic 1526 (e.g., a jungle). A similar animation effect may be displayed for characters 1528 that reach zero remaining spins.

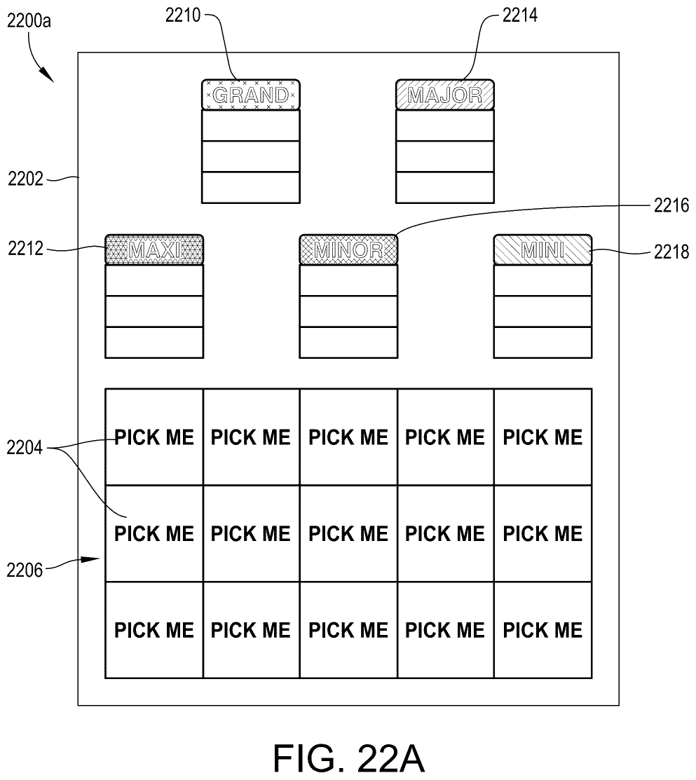

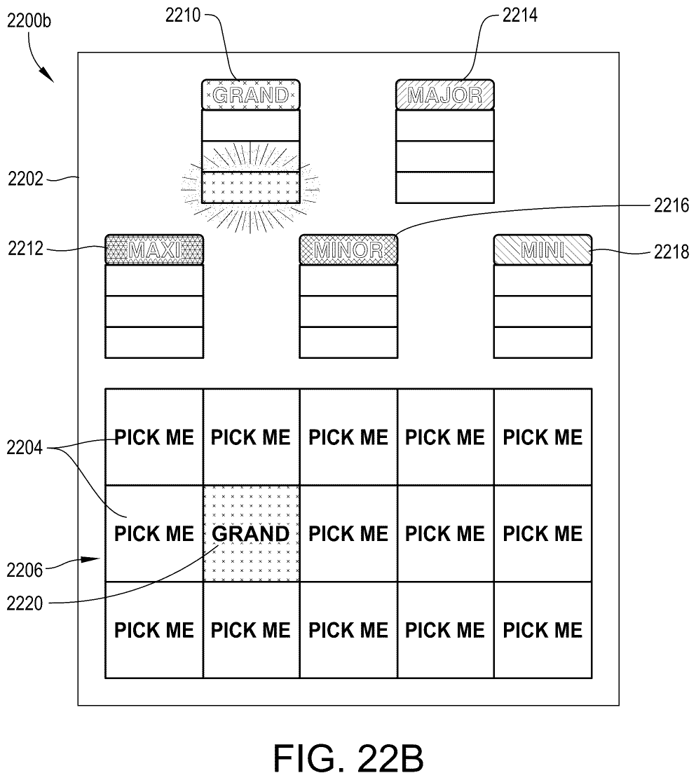

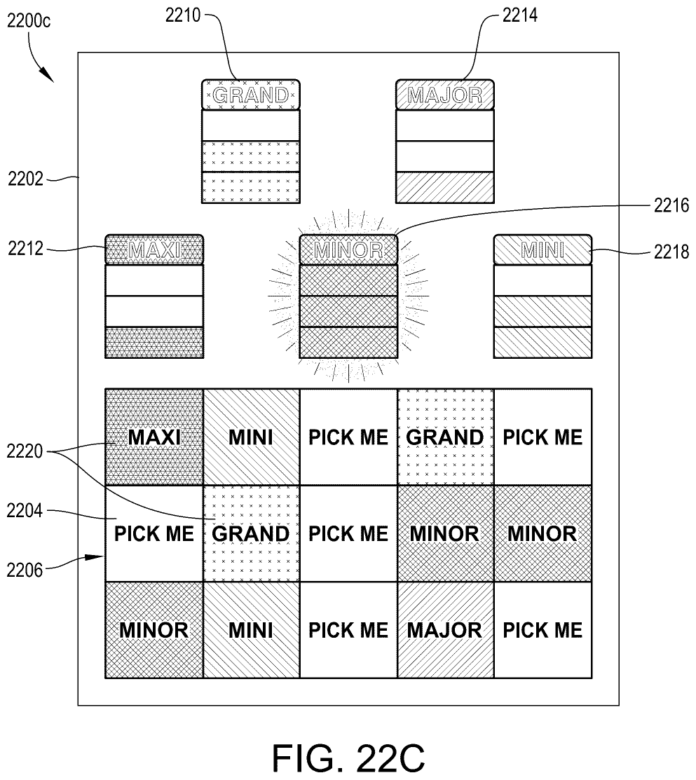

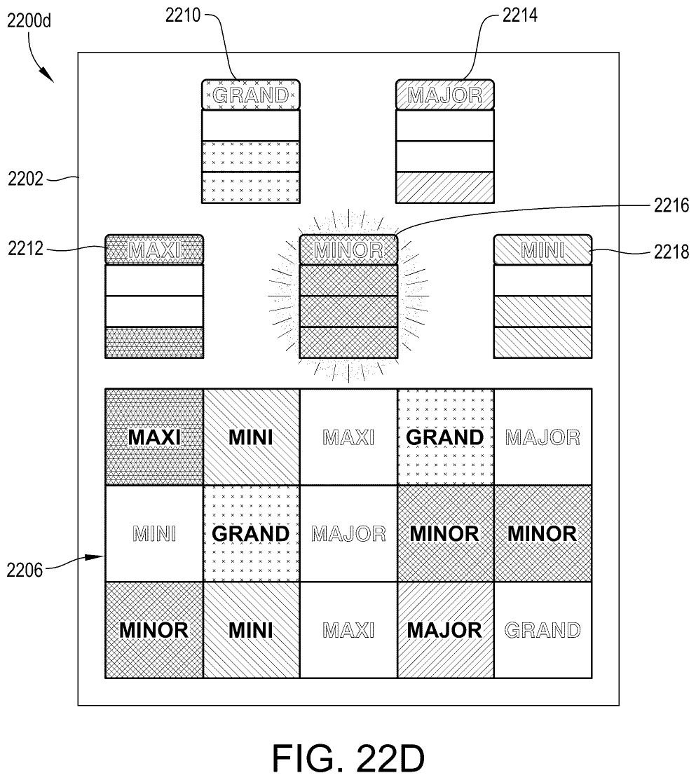

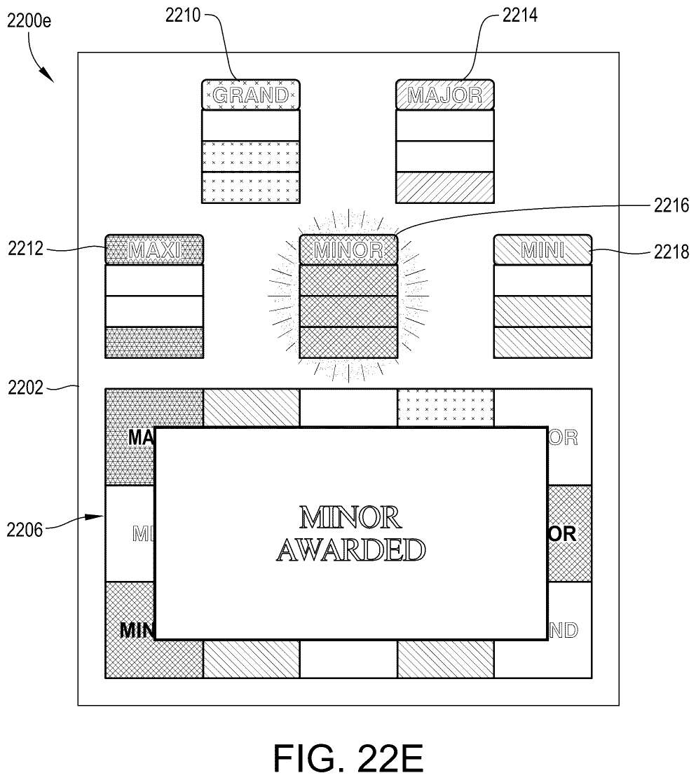

When a character 1528 is defeated or reaches zero remaining spins, the processor 204 may determine, at operation 1444a or 1444b, whether a feature game or bonus game (e.g., a pick bonus game shown in FIG. 22) is triggered. The determination at operation 1444a or 1444b may be made based on a generated RNG outcome that maps to a decision for triggering the feature game, or another suitable trigger condition may be used. In the example implementation, each time a character 1528 is removed/replaced (whether because the number of spins reaching zero or because the character is defeated), an RNG outcome is generated to determine whether to trigger the feature game.

To visually indicate that the removed character 1528 generates a chance to trigger the feature game, the animation effect 2102 of FIG. 21 may include transforming the metamorphic 1526 that “collects” the removed character. For example, in response to a character 1528 being removed and collected to the metamorphic 1526, the processor 204 may control the UI 1502 to transform the metamorphic by changing the size of the metamorphic or some other transformation. In some implementations, the metamorphic 1526 may change between different states depending on the number of characters 1528 that have been collected since the last occurrence of the feature game being triggered. Moreover, transformation of the metamorphic 1526 as part of the animation effect 2102 may be for visual information purposes only, and the probability that the feature game will be triggered does not change regardless of the number of characters 1528 that have been collected by the metamorphic 1526. In other examples, the metamorphic 1526 may transform and the probability of triggering the feature game may also change as more characters 1528 are collected by the metamorphic.

FIGS. 22A-22E show a sequence of screen captures 2200a-2200e of a pick bonus game that may be triggered at operation 1444a when a character 1528 is defeated or at operation 1444b when a character 1528 reaches zero remaining spins. The processor 204 may control display of the pick bonus game using a feature UI 2202 (e.g., a bonus game play UI 308 shown in FIG. 3). The example pick bonus game of FIG. 22 includes display, by the UI 2202, of pick icons 2204 arranged in a matrix (e.g., pick icon matrix 2206) including a number of rows (or pick icon positions) and columns. The pick icon matrix 2206 has a 3×5 configuration in the illustrated example, each column having three positions for three pick icons 2204 such that the matrix 2206 includes fifteen pick icons total. The configuration of the pick icon matrix 2206 may vary, for example, the pick icon matrix may include more or fewer pick icons 2204. The UI 2202 also provides a collection area 2208 with five jackpot grids 2210-2218. Each jackpot grid 2210-2218 is associated with one of the jackpot meters 1516-1524 provided by the UI 1502. In particular, the UI 2202 includes a grand jackpot grid 2210 associated with the grand jackpot meter 1516, a maxi jackpot grid 2212 associated with the maxi jackpot meter 1518, a major jackpot grid 2214 associated with the major jackpot meter 1520, a minor jackpot grid 2216 associated with the minor jackpot meter 1522, and a mini jackpot grid 2218 associated with the mini jackpot meter 1524.

During the pick bonus game, a player selection of a pick icon 2204 may reveal an outcome or a prize 2220 of the pick icon. Each prize 2220 is collected by one of the jackpot grids 2210-2218. The player may continue to select pick icons 2204 and reveal the prizes 2220 until one of the jackpot grids 2210-2218 is completely filled with collected prizes 2220. FIG. 22C shows the minor jackpot grid 2216 completely filled. The corresponding jackpot (e.g., the minor jackpot) may then be awarded, shown in FIG. 22E. As shown in FIG. 22D, in some examples, the outcome of pick icon(s) 2204 that have not been selected by a player once one of the grids 2210-2218 is filled may also be revealed at the conclusion of the pick bonus game.

A computer, controller, or server, such as those described herein, includes at least one processor or processing unit and a system memory. The computer, controller, or server typically has at least some form of computer readable non-transitory media. As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit, and other programmable circuits “configured to” carry out programmable instructions, and these terms are used interchangeably herein. In the embodiments described herein, memory may include, but is not limited to, a computer-readable medium or computer storage media, volatile and nonvolatile media, removable and non-removable media implemented in any method or technology for storage of information such as computer readable instructions, data structures, program modules, or other data. Such memory includes a random access memory (RAM), computer storage media, communication media, and a computer-readable nonvolatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

As indicated above, the process may be embodied in computer software. The computer software could be supplied in a number of ways, for example on a tangible, non-transitory, computer readable storage medium, such as on any nonvolatile memory device (e.g., an EEPROM). Further, different parts of the computer software can be executed by different devices, such as, for example, in a client-server relationship. Persons skilled in the art will appreciate that computer software provides a series of instructions executable by the processor.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A gaming system comprising:
a processor; and
a memory storing instructions thereon which, when executed by the processor, cause the processor to:
control a display device to display an electronic game including a set of reels and transient characters, wherein each transient character is associated with one of the reels and is displayed for a predetermined number of spins;
randomly determine a prize and a number of health points for each transient character;
control the display device to spin and stop the set of reels and display a set of symbols on each stopped reel;
determine, for each stopped reel, whether the set of symbols includes an attack symbol that causes the number of health points of the transient character associated with the reel to reach zero;
when the number of health points for any of the transient characters reaches zero, generate an award that includes the prize for the transient character having zero health points;
control the display device to remove each transient character having zero remaining spins, determined after the reels are stopped; and
for each removed transient character, control the display device to display a new transient character and determine a prize and a number of health points for the new transient character.

2. The gaming system of claim 1, wherein the instructions, when executed, further cause the processor to randomly determine the prize and number of health points for each transient character and each new transient character by:
performing a first lookup in a first lookup table to select a type of character;
based on the selected type of character, determining a second lookup table from a plurality of second lookup tables each associated with different types of characters; and
performing a second lookup in the determined second lookup table to determine the prize and number of health points.

3. The gaming system of claim 1, wherein, when the number of health points for any of the transient characters reaches zero, the instructions, when executed, further cause the processor to restore each transient character having zero remaining health points after the respective award is generated.

4. The gaming system of claim 1, wherein, when the number of health points for a transient character having a free spins prize reaches zero, the instructions, when executed, cause the processor to initiate a free spins feature game on the display device.

5. The gaming system of claim 4, wherein the free spins feature game includes display of feature characters each associated with one feature reel of a set of feature reels, wherein each feature character has a prize and a number of health points determined when the free spins feature game is initiated.

6. The gaming system of claim 1, wherein the instructions, when executed, further cause the processor to dynamically determine a number of damage points caused by each attack symbol appearing on each reel to the transient character associated with the reel.

7. The gaming system of claim 1, wherein the instructions, when executed, further cause the processor to control the display device to visually indicate that each transient character having at least one remaining spin, determined after the reels are stopped, has one fewer remaining spin than before the reels are spun and stopped.

8. A non-transitory computer-readable medium containing instructions stored thereon, which when executed by a processor, cause the processor to:
control a display device to display an electronic game including a set of reels and transient characters, wherein each transient character is associated with one of the reels and is displayed for a predetermined number of spins;
randomly determine a prize and a number of health points for each transient character;
control the display device to spin and stop the set of reels and display a set of symbols on each stopped reel;
determine, for each stopped reel, whether the set of symbols includes an attack symbol that causes the number of health points of the transient character associated with the reel to reach zero;
when the number of health points for any of the transient characters reaches zero, generate an award that includes the prize for the transient character having zero health points;
control the display device to remove each transient character having zero remaining spins, determined after the reels are stopped; and
for each removed transient character, control the display device to display a new transient character and determine a prize and a number of health points for the new transient character.

9. The non-transitory computer-readable medium of claim 8, wherein the instructions, when executed, further cause the processor to randomly determine the prize and number of health points for each transient character and each new transient character by:
performing a first lookup in a first lookup table to select a type of character;
based on the selected type of character, determining a second lookup table from a plurality of second lookup tables each associated with different types of characters; and
performing a second lookup in the determined second lookup table to determine the prize and number of health points.

10. The non-transitory computer-readable medium of claim 8, wherein, when the number of health points for any of the transient characters reaches zero, the instructions, when executed, further cause the processor to restore each transient character having zero remaining health points after the respective award is generated.

11. The non-transitory computer-readable medium of claim 8, wherein, when the number of health points for a transient character having a free spins prize reaches zero, the instructions, when executed, cause the processor to initiate a free spins feature game on the display device.

12. The non-transitory computer-readable medium of claim 11, wherein the free spins feature game includes display of feature characters each associated with one feature reel of a set of feature reels, wherein each feature character has a prize and a number of health points determined when the free spins feature game is initiated.

13. The non-transitory computer-readable medium of claim 8, wherein the instructions, when executed, further cause the processor to dynamically determine a number of damage points caused by each attack symbol appearing on each reel to the transient character associated with the reel.

14. The non-transitory computer-readable medium of claim 8, wherein the instructions, when executed, further cause the processor to control the display device to visually indicate that each transient character having at least one remaining spin, determined after the reels are stopped, has one fewer remaining spin than before the reels are spun and stopped.

15. A computer-implemented method for providing an electronic game on an electronic gaming device, the method comprising:
controlling a display device to display the electronic game including a set of reels and transient characters, wherein each transient character is associated with one of the reels and is displayed for a predetermined number of spins;
randomly determining a prize and a number of health points for each transient character;
controlling the display device to spin and stop the set of reels and display a set of symbols on each stopped reel;
determining, for each stopped reel, whether the set of symbols includes an attack symbol that causes the number of health points of the transient character associated with the reel to reach zero;
when the number of health points for any of the transient characters reaches zero, generating an award that includes the prize for the transient character having zero health points;
controlling the display device to remove each transient character having zero remaining spins, determined after the reels are stopped; and
for each removed transient character, controlling the display device to display a new transient character and determining a prize and a number of health points for the new transient character.

16. The method of claim 15, further comprising randomly determining the prize and number of health points for each transient character and each new transient character by:
performing a first lookup in a first lookup table to select a type of character;
based on the selected type of character, determining a second lookup table from a plurality of second lookup tables each associated with different types of characters; and
performing a second lookup in the determined second lookup table to determine the prize and number of health points.

17. The method of claim 15, further comprising restoring each transient character having zero remaining health points after the respective award is generated.

18. The method of claim 15, further comprising, when the number of health points for a transient character having a free spins prize reaches zero, initiating a free spins feature game on the display device, wherein the free spins feature game includes display of feature characters each associated with one feature reel of a set of feature reels, wherein each feature character has a prize and a number of health points determined when the free spins feature game is initiated.

19. The method of claim 15, further comprising dynamically determining a number of damage points caused by each attack symbol appearing on each reel to the transient character associated with the reel.

20. The method of claim 15, further comprising controlling the display device to visually indicate that each transient character having at least one remaining spin, determined after the reels are stopped, has one fewer remaining spin than before the reels are spun and stopped.
